(19) United States
(12) Patent Application Publication
(10) Pub. No.: US 2024/0028984 A1
(43) Pub. Date: Jan. 25, 2024

(54) METHOD FOR ASSESSING WORKLOAD IN AN ORGANIZATION

(71) Applicant: Chad Luedtke, Foothills MD (CA)

(72) Inventor: Chad Luedtke, Foothills MD (CA)

(21) Appl. No.: 18/337,263

(22) Filed: Jun. 19, 2023

Related U.S. Application Data
(60) Provisional application No. 63/390,794, filed on Jul. 20, 2022.

(51) Int. Cl. G06Q 10/0631

(52) U.S. Cl. CPC G06Q 10/0631

(57) ABSTRACT

A method for assessing workload in an organization comprises the steps of (i) providing, in a database system, work entries representative of work performable by one or more workers in relation to one or more matters; (ii) retrieving, from the database system, respective work entries associated with a selected matter for which workload is to be assessed; (iii) based on a selected one of plural work measurement rulesets (WMR), generating respective ruleset-assessed entries for relevant work entries of the selected matter, which have the types of work identified in the selected WMR, and each ruleset-assessed entry including data representative of the selected matter, the type of work, a rule-defined value based on a corresponding rule of the WMR, and the worker; and (iv) storing the ruleset-assessed entries in the database system distinctly from the work entries.

### FIELD OF THE INVENTION

The present invention relates generally to a method for assessing workload in an organization, for whom a plurality of workers perform work of different types and on different matters, and more particularly to such a method in which work entries, representative of work performable by one or more of the workers in relation to an associated one of the matters and which do not contain a measured value of the work, are distinctly stored.

### BACKGROUND

There are several industries in which work is tracked for various purposes including to determine remuneration and to assess productivity. Conventionally, a workload measurement system (WMS) is used to measure workload, which includes a set of instructions or rules with two fundamental functions, namely (i) to define a discrete task, job, duty or, more generally speaking, a type of work, and (ii) to assign a value to that type of work, typically a duration of time it is worth. However, even within a common industry, there may not be consensus on a single WMS; WMS's may vary in at least the following manners, namely (i) the defined types of work, that is a first WMS may define a type of work that is not defined or recognized in another WMS, and (ii) the values assigned to the defined types of work.

### SUMMARY OF THE INVENTION

According to an aspect of the invention there is provided a method for assessing workload in an organization for whom a plurality of workers perform work of different types and on different matters, the method comprising:
providing, in a database system including one or more databases, a plurality of work entries respectively representative of the work performable by one or more of the workers in relation to an associated one of the matters, wherein each of the work entries includes data representative of:
   the associated matter,
   one of the types of work, and
   one of the workers;
retrieving, from the database system, respective ones of the work entries associated with a selected one of the matters for which workload is to be assessed;
based on a selected one of a plurality of work measurement rulesets each comprising one or more rules respectively associated with the types of work that can be performed, generating respective ruleset-assessed entries for relevant ones of the work entries of the selected matter indicating the types of work identified in the selected work measurement ruleset, wherein each of the ruleset-assessed entries comprises data representative of:
   the selected matter;
   the type of work,
   a rule-defined value of the work based on a corresponding one of the rules of the ruleset and the type of work, and
   the worker; and
storing the ruleset-assessed entries in the database system distinctly from the work entries such that both the ruleset-assessed and work entries are available for subsequent retrieval.

According to another aspect of the invention there is provided a system for assessing workload in an organization for whom a plurality of workers perform work of different types and on different matters;
wherein the system is operatively communicated with a database system, which includes one or more databases, storing thereon a plurality of work entries respectively representative of the work performable by one or more of the workers in relation to an associated one of the matters, wherein each of the work entries includes data representative of:
   the associated matter,
   one of the types of work, and
   one of the workers;
wherein the system comprises:
at least one computer processor; and
a non-transitory readable storage medium having computer readable codes stored thereon which when executed by the at least one computer processor perform the steps of:
retrieving, from the database system, respective ones of the work entries associated with a selected one of the matters for which workload is to be assessed;
based on a selected one of a plurality of work measurement rulesets each comprising one or more rules respectively associated with the types of work that can be performed, generating respective ruleset-assessed entries for relevant ones of the work entries of the selected matter indicating the types of work identified in the selected work measurement ruleset, wherein each of the ruleset-assessed entries comprises data representative of:
   the selected matter;
   the type of work,
   a rule-defined value of the work based on a corresponding one of the rules of the ruleset and the type of work, and
   the worker; and
storing the ruleset-assessed entries in the database system distinctly from the work entries such that both the ruleset-assessed and work entries are available for subsequent retrieval.

According to yet another aspect of the invention there is provided a non-transitory readable storage medium configured for operative coupling to at least one computer processor and having computer readable codes stored thereon which when executed by the at least one computer processor perform the steps of:
retrieving, from the database system, respective ones of the work entries associated with a selected one of the matters for which workload is to be assessed;
based on a selected one of a plurality of work measurement rulesets each comprising one or more rules respectively associated with the types of work that can be performed, generating respective ruleset-assessed entries for relevant ones of the work entries of the selected matter indicating the types of work identified in the selected work measurement ruleset, wherein each of the ruleset-assessed entries comprises data representative of:
   the selected matter;
   the type of work,
   a rule-defined value of the work based on a corresponding one of the rules of the ruleset and the type of work, and
   the worker; and
storing the ruleset-assessed entries in the database system distinctly from the work entries such that both the ruleset-assessed and work entries are available for subsequent retrieval.

These provide distinct work entries and ruleset-assessed entries, which include at least some of the same information as the work entries but additionally include a rule-defined value for the work represented thereby, such that different work measurement rulesets can be applied to the same work entries.

In one arrangement, after generating respective ruleset-assessed entries for relevant ones of the work entries indicating the types of work identified in the selected work measurement ruleset, the method further includes receiving, from a user conducting an assessment of workload, a modification to a respective one of the rules of the work measurement ruleset and displaying a differential value representative of a cumulative change in modified rule-defined values of affected ones of the ruleset-assessed entries based on the modified rule.

In one arrangement, after generating respective ruleset-assessed entries for relevant ones of the work entries indicating the types of work identified in the selected work measurement ruleset, the method further includes receiving, from a user conducting an assessment of workload, a modification to a cumulative value representative of all of the rule-defined values of the ruleset-assessed entries and determining a modification to the work measurement rulesets to effect the modification to the cumulative value.

Generating respective ruleset-assessed entries for relevant ones of the work entries of the selected matter may be iterated for multiple ones of the work measurement rulesets applied to the selected matter.

Storing the ruleset-assessed entries in the database system distinctly from the work entries may comprise grouping the ruleset-assessed entries by at least one of (i) the rules of the selected workload measurement ruleset, (ii) the selected matter, and (iii) the selected workload measurement ruleset.

Preferably, when the work entries include data indicating whether the work represented thereby has been completed, and the ruleset-assessed entries include said data, the method further includes generating a work report including only prescribed ones of the ruleset-assessed entries with data indicating that the work represented thereby is complete.

In one such arrangement, generating a work report including only prescribed ones of the ruleset-assessed entries comprises the prescribed ruleset-assessed entries of one of (i) a common one of the matters, (ii) a common one of the workers, and (iii) a common one of the types of work.

In one arrangement, the method further includes:
receiving, as input, a user-generated document having a plurality of fields respectively containing data in the form of at least one of text and numbers and representative of work in relation to a respective one of the matters; and
generating work entries based on the data in the fields of the user-generated document.

In one arrangement, when one or more of the relevant work entries are determined to be unassigned to the workers, generating respective ruleset-assessed entries for relevant ones of the work entries of the selected matter indicating the types of work identified in the selected work measurement ruleset comprises generating one or more estimated ruleset-assessed entries with the data representative of one of the matters, the type of work and the rule-defined value of the work but without the data indicating the worker.

In one such arrangement, the method further includes remotely transmitting the estimated ruleset-assessed entries to relevant ones of the workers identified as capable of performing the type of work indicated in the estimated ruleset-assessed entries to procure one of the relevant workers to perform the work represented thereby.

### BRIEF DESCRIPTION OF THE DRAWINGS

The invention will now be described in conjunction with the accompanying drawings in which:

FIG. 1 is a schematic diagram of a computing system within which the method of the present invention is performed;

FIG. 2 is a schematic diagram of data structures in the method of the present invention;

FIG. 3 is a flowchart of an arrangement of method according to the present invention;

FIG. 4 is a flowchart showing additional steps of the arrangement of method of FIG. 3;

FIG. 5 is a flowchart showing additional steps of the arrangement of method of FIG. 3;

FIG. 6 is a flowchart showing additional steps of the arrangement of method of FIG. 3; and

FIGS. 7-14 are diagrams showing data structures and constituent processes or methods of an arrangement of method of the present invention.

In the drawings like characters of reference indicate corresponding parts in the different figures.

### DETAILED DESCRIPTION

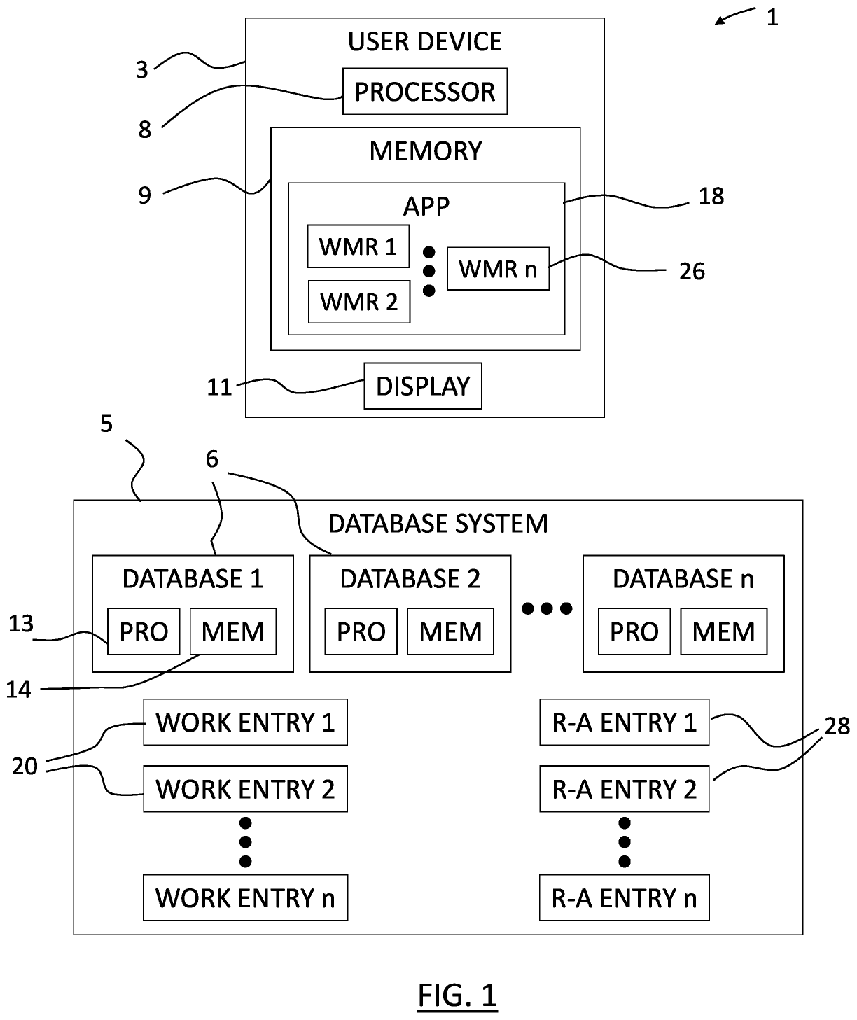

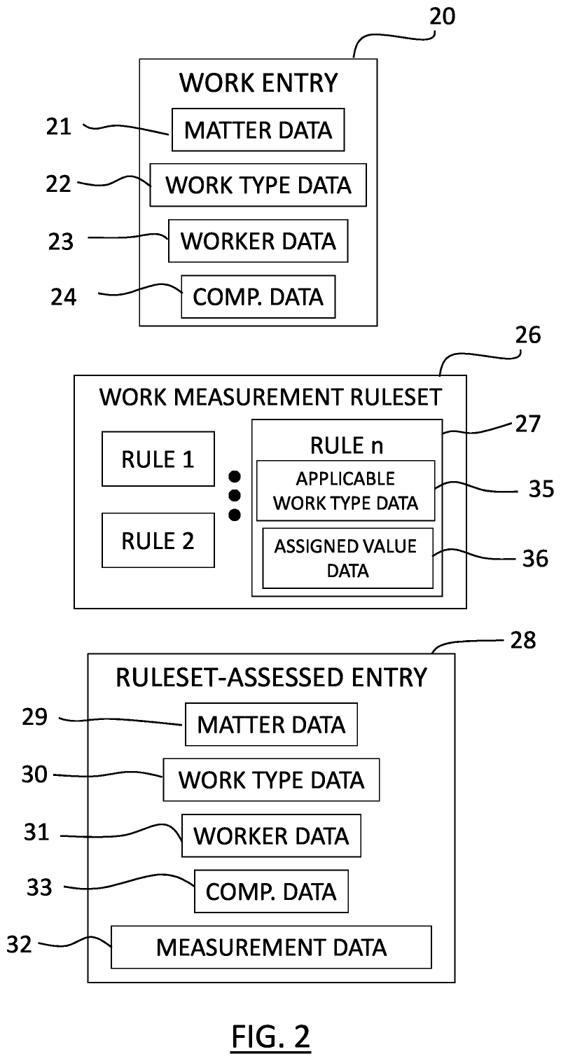

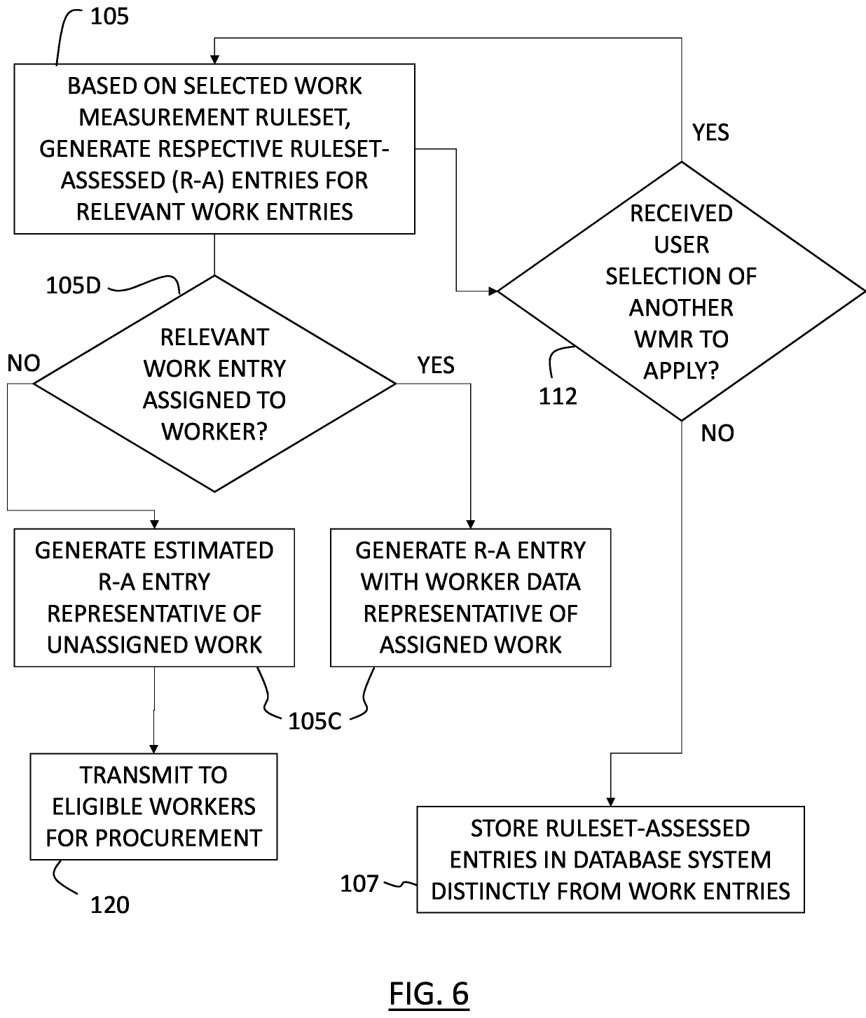

Referring to the accompanying drawings, and particularly FIGS. 1-6, there is shown a method, generally indicated at 100 (FIG. 2), for assessing workload in a (commercial) organization for whom a plurality of workers perform work of different types and on different matters. The different types of work are different tasks, jobs, activities and duties, which are discrete, meaning they are individually separate and distinct from each other. ‘Matters’ are different projects, files or cases, which are discrete.

The method 100 is performed on a computing system 1 formed by a user device 3, such as a smartphone or personal computer, and a database system 5, including one or more databases 6, with which the user device 3 is communicatively coupled, for example by a communication network, to exchange data. The user device 3 generally comprises a processor 8, a non-transitory readable storage medium 9 operatively coupled thereto and a display 11 operatively coupled to the processor and configured to display information to the user. The user device 3 is configured to receive input from a user operating the same, for example by way of a touch sensitive display or a peripheral device such as a keyboard. The one or more databases 6 of the database system generally respectively comprise servers (server computers) having processors 13 and non-transitory memories or readable storage mediums 14 coupled thereto and configured to store data.

Typically, computer instructions for executing the method 100 are stored in an application or software program 18 stored on the user device 3 thus forming a system for assessing workload in the organization, which is operatively communicated with the database system 5.

The database system 5 has stored thereon a plurality of work entries 20 respectively representative of the work performable by one or more of the workers in relation to an associated one of the matters. That is, each work entry represents work performable by one of the workers in relation to one of the matters. As shown more clearly in FIG. 2, each work entry includes data representative of, at minimum, (i) the associated matter, as indicated at 21, (ii) one of the types of work, as indicated at 22, and (iii) one of the workers, that is their identity or identifying information thereof, as indicated at 23. Optionally, the work entries respectively include data indicating whether the work represented thereby has been completed, as indicated at 24, which is referred to as ‘completeness data’ for convenience. Completeness data may comprise beginning and end dates, for example. Also, the work entries may additionally include data representative of over-time work, that is whether the work associated with a particular work entry is considered additional to or beyond contractual obligations to the organization of the worker associated with the work entry.

Typically, the work entries 20 are generated prior to execution of the method 100, so as to be predefined relative to execution of the method steps described in further detail hereinafter. Thus, the work entries 20 are provided in the database system, so as to be available for retrieval therefrom. However, in some instances, the method 100 may include a step 101 of generating at least some of the work entries for storage in the database system, as will be better appreciated later.

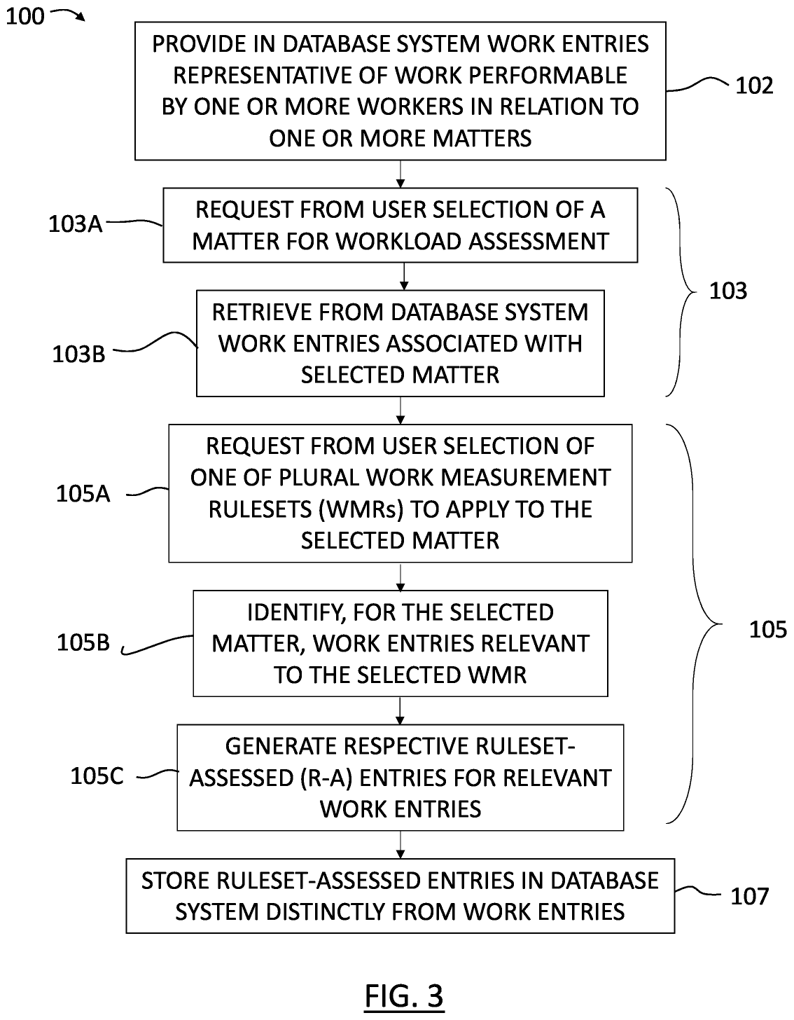

Turning now to the method 100, and with reference to FIG. 3, this generally comprises the steps of:
a) providing, in the database system 5, a plurality of the work entries as indicated at 102;
b) retrieving, from the database system 5, respective ones of the work entries associated with a selected one of the matters for which workload is to be assessed, as indicated at 103;
c) based on a selected one of a plurality of work measurement rulesets 26 (WMRs) each comprising one or more rules 27 respectively associated with the types of work that can be performed, generating respective ruleset-assessed entries 28 for relevant ones of the work entries of the selected matter indicating the types of work identified in the selected work measurement ruleset, as indicated at 105; and
d) storing the ruleset-assessed entries 28 in the database system distinctly from the work entries 20 such that both the ruleset-assessed and work entries are available for subsequent retrieval, from the database system, as indicated at 107.

With reference to FIG. 2, each of the ruleset-assessed entries (which may be referred to as R-A entries for convenience, especially in the drawings) comprises data representative of (i) the selected matter, as indicated at 29, (ii) the type of work, as indicated at 30, (iii) a rule-defined value of the work based on a corresponding one of the rules of the ruleset and the type of work, as indicated at 31, and (iv) the worker, as indicated at 32. When the work entries 20 also include completeness data 24, the ruleset-assessed entries also include the same, as indicated at 33. Basically, the ruleset-assessed entries 28 include the same data as the work entries 20, except that the ruleset-assessed entries additionally contain rule-defined values, which is referred to as ‘measurement data’ for convenience, and derived from application of one of the work measurement rulesets to a prescribed one of the work entries that is relevant. The data in a respective one of the ruleset-assessed entries 28 that is in common with a corresponding one of the work entries 20 may be in the form of a link or pointer to the corresponding work entry, so as to reduce an amount of data associated with the ruleset-assessed entries and therefore stored in the database system 5.

Typically, each work measurement ruleset 26 is stored in the application 18 and comprises data representative of the various rules of the set. Each rule 27 comprises data representative of, at minimum, (i) the type of work to which the rule relates or is applicable, as indicated at 35, and (ii) an assigned value of the type of work, as indicated at 36. Optionally, each rule further includes data representative of conditions describing scenarios in which the assigned value may be modified based on other data in a relevant work entry, for example, due to the worker or the matter of the relevant work entry.

As shown in FIG. 3, more specifically, the general step 103 of retrieving work entries associated with the selected matter typically comprises constituent steps of:
as indicated at 103A, requesting, from a user conducting an assessment of workload, input as to the selected matter for workload assessment, in other words requesting from the user selection of one of the matters for workload assessment; and
based on the user's input of a selected matter, retrieving associated ones of the work entries, as indicated at 103B.

The general step 105 of generating respective ruleset-assessed entries for the selected matter more specifically typically comprises constituent steps of:
requesting, from the user conducting the assessment of workload, input as to the selected work measurement ruleset to apply to the selected matter, in other words requesting from the user selection of one of the work measurement rulesets to measure workload of the selected matter, as indicated at 105A;
as indicated at 105B, identifying, for the selected matter, work entries which are relevant to the selected work measurement ruleset, that is work entries associated with the selected matter that additionally indicate the types of work identified in the selected work measurement ruleset; and
generating the respective ruleset-assessed entries for the relevant work entries, as indicated at 105C.

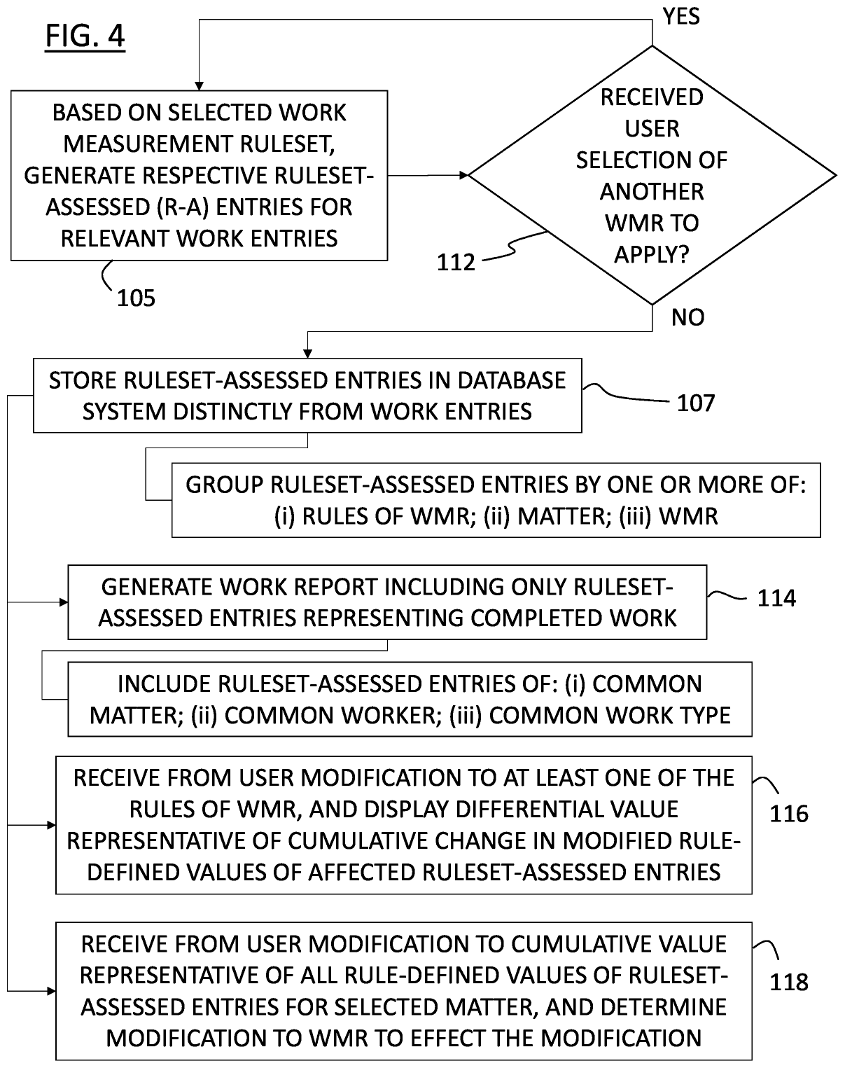

Since there are multiple work measurement rulesets available, step 105 of generating ruleset-assessed entries may be iterated for multiple work measurement rulesets applied to the selected matter. Thus, after generating ruleset-assessed entries based on an initially selected one of the work measurement rulesets, the method may include a step of requesting user selection of another one of the work measurement rulesets to apply to the same matter (to which the initial WMR was applied), as represented by step 112 in FIG. 4. As such, the ruleset-assessed entries of different WMRs can be compared.

Still referring to FIG. 4, to assist in organizing or categorizing the generated ruleset-assessed entries, in the illustrated arrangement the step 107 of storing the ruleset-assessed entries in the database system distinctly from the work entries comprises grouping the ruleset-assessed entries 28 by at least one of (i) the rules of the selected workload measurement ruleset, (ii) the selected matter, and (iii) the selected workload measurement ruleset. These groups of ruleset-assessed entries may be temporary and dynamically formed, for example, using a filtering function of the system configured to assess workload in the organization.

It will be appreciated that the method steps b) through d) above, that is those steps indicated at 103, 105 and 107, may be iterated for multiple matters.

With continued reference to FIG. 4, after the step of generating ruleset-assessed entries for at least one matter, and preferably after the step of storing the same, the method can include any of a number of analysis type steps performed on the generated work measurement data including:
i) as indicated at 114, generating a work report including only prescribed ones of the ruleset-assessed entries with data indicating that the work represented thereby is complete, and the prescribed ruleset-assessed entries may comprise of one of (1) a common matter, (2) a common worker, and (3) a common work type;
ii) receiving, from the user conducting an assessment of workload, a modification to a respective one of the rules of the work measurement ruleset and displaying a differential value representative of a cumulative change in modified rule-defined values of affected ones of the ruleset-assessed entries based on the modified rule, as indicated at 116; and
iii) receiving, from the user conducting an assessment of workload, a modification to a cumulative value representative of all of the rule-defined values of the ruleset-assessed entries, typically of a common one of the matters, that is the selected matter, and determining a modification to the work measurement rulesets to effect the modification to the cumulative value, as indicated at 118.

These analysis steps are generally independent of one another, that is they are available as independent optional steps in the method.

More specifically, step 114 includes a constituent step of retrieving, from the database system 5, the prescribed ruleset-assessed entries. The generated work report may be displayed to the user or stored in the database system for later retrieval.

Step 116 is basically a rule-editing tool. Typically, in this step, at least one rule of a respective one of the WMRs is temporarily modified according to user-input. The displayed differential value enables the user to interpret the implications of the proposed modification. Subsequently, the method preferably includes a step of requesting, from the user, input to either accept or reject the modification, that is to confirm the modification. If the modification is confirmed, the corresponding rule is updated in the WMR. Preferably, the system includes a log of rule modifications.

Step 118 is basically a rule-modification suggestion tool. The system may identify one or more modifications to one or more of the rules of a respective one of the WMRs to effect the modification to the cumulative value. Preferably, the method includes a step of requesting, from the user, selection of one of the rule modifications. Preferably, the system includes a log of rule modifications, which may be the same log mentioned in respect of step 116.

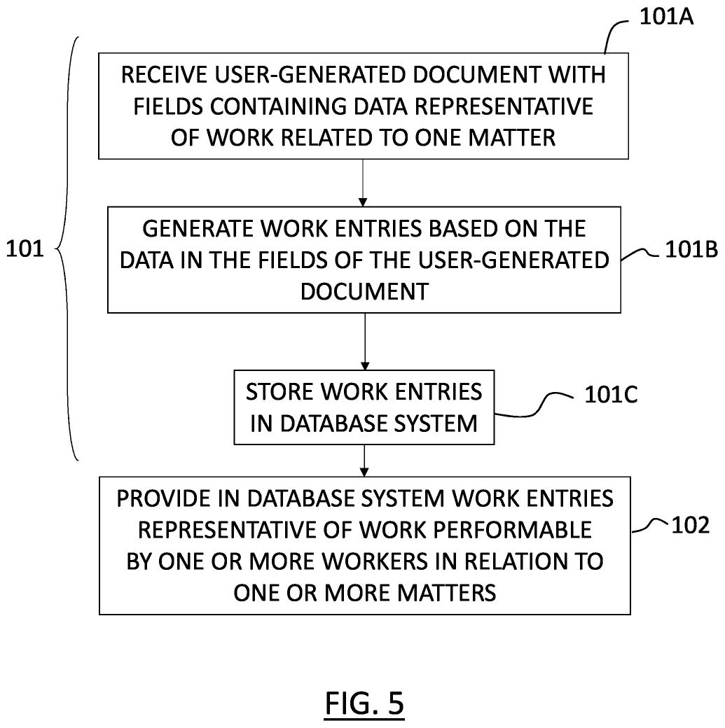

As previously suggested, and with reference to FIG. 5, the method optionally includes a step of generating at least some of the work entries for storage in the database system 5, as indicated at 101. In one arrangement, that step more specifically includes:
receiving, as input, a user-generated document having a plurality of fields respectively containing data in the form of at least one of text and numbers and representative of work in relation to a respective one of the matters, as indicated at 101A; and
generating work entries based on the data in the fields of the user-generated document, as indicated at 101B.

Furthermore, step 101 preferably includes a constituent step 101C of storing the work entries derived from the user-generated document in the database system 101C, so that those work entries can be provided at method step 102.

In some instances, one or more of the work entries, to which the selected work measurement ruleset is applied, are determined to be unassigned to the workers. Typically, such work entries are free of data indicating one of the workers, that is the data 23, and when the entries include completeness data, then such entries are also free of at least some completeness data 24 (when completeness data includes multiple discrete components). Such work entries, which denote or indicate work that has not been assigned to one of the workers, can still be processed as part of the method. In this case, the step 105 of generating respective ruleset-assessed entries for relevant work entries of the selected matter based on a selected WMR comprises generating one or more estimated ruleset-assessed entries with the data representative of one of the matters 29, the type of work 30 and the rule-defined value of the work 32 but without the data indicating the worker normally found at 31 and at least some of the completeness data found at 33. That is, the estimated ruleset-assessed entries are of the same structure as the ruleset-assessed entries 28, except that certain data fields are empty. The estimated ruleset-assessed entries represent work which has not yet been completed because the work represented thereby has not yet been assigned for someone to perform.

Accordingly, for the relevant work entries determined to be assigned, these contain worker data 23 and corresponding completeness data 24, and represent work which has been assigned to one of the workers of the organization.

Thus, step 105 includes, after the step of identifying relevant work entries at 105B and before generating ruleset-assessed entries at step 105C, so as to be intermediate the same, a constituent step 105D of checking, for each one of the relevant work entries, whether the work entry is assigned or unassigned. This step 105D may comprise checking whether the work entry has worker data 23. If it is determined that the work entry is unassigned, then the step 105C of generating a ruleset-assessed entry is performed, except that the resultant ruleset-assessed entry (for the relevant unassigned work entry) also lacks worker data and corresponding completeness data. If it is determined that the work entry has been assigned, then step 105C is performed, and the resultant ruleset-assessed entry includes worker data and corresponding completeness data. In other words, regardless of whether a relevant work entry is assigned or unassigned, the step of generating ruleset-assessed entries is the same, and the worker data and completeness data is simply carried over from the corresponding work entries. As previously mentioned, the data structure for an estimated ruleset-assessed entry is the same as that for an assigned ruleset-assessed entry, with data fields available to be filled once the estimated ruleset-assessed entry has been assigned. As such, an estimated ruleset-assessed entry may be alternatively referred to as an unassigned ruleset-assessed entry, which is necessarily representative of uncompleted work.

The estimated ruleset-assessed entries are also stored in the database system at step 107.

In one such arrangement with estimated ruleset-assessed entries, the method further includes a step 120 of remotely transmitting the estimated ruleset-assessed entries to relevant ones of the workers identified as capable of performing the type of work indicated in the estimated ruleset-assessed entries to procure one of the relevant workers to perform the work represented thereby. That is, step 120, which typically would be performed after the ruleset-assessed entries have been stored in the database system 107, includes constituent a step of retrieving, from the database system, selected ones of the estimated ruleset-assessed entries.

Other independent optional steps performed after ruleset-assessed entries have been generated, and also preferably after the storing step 107, include:
based on the ruleset-assessed entries indicating completed work, generating an invoice for selected ones of the ruleset-assessed entries based on time-based rates for the workers indicated in the selected ruleset-assessed entries;
based on data representative of one or more of the workers' respective contractual obligations to the organization, including a contracted workload, which may be measured by number of workdays, for which the workers are respectively expected to (perform) work, and the ruleset-assessed entries associated with completed work, determining, for a selected or respective one of the workers, a remaining contractual workload, for example a number of remaining workdays in a prescribed duration (typically denoted in the contract, a contractual work period); and
when the work entries additionally include data representative of duration of work, that is start and end dates, determining, for a selected or respective one of the workers, turn-around time for one or more of the ruleset-assessed entries associated with completed work, that is time actually taken to complete the work associated with one or more selected ruleset-assessed entries.

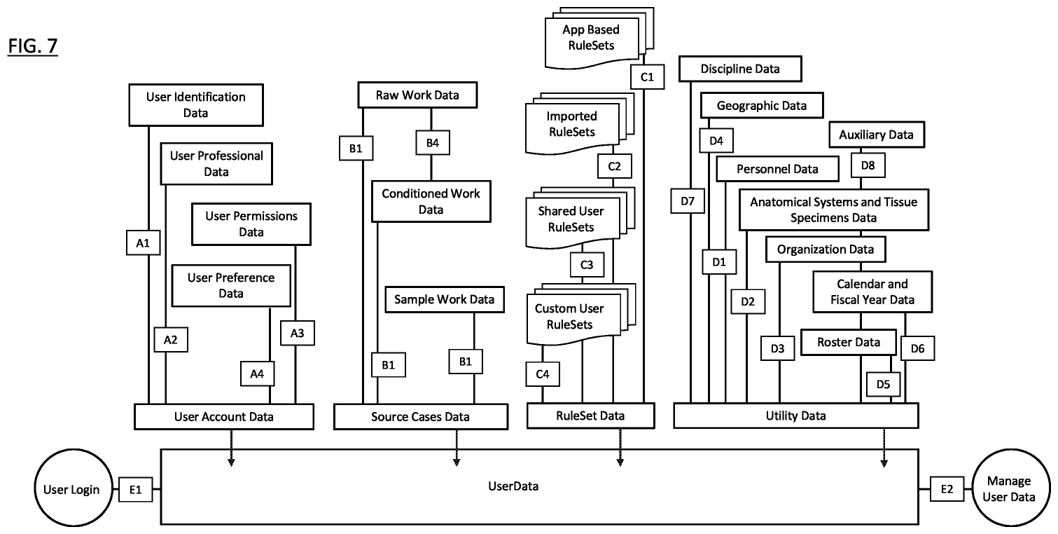

FIGS. 7-14 show data structures and constituent processes or methods of a variation of the arrangement of method of FIG. 2. The steps of method 100 as illustrated in FIG. 2 and described in further detail above are applicable to the variation of method represented by FIGS. 7-14. However, FIGS. 7-14 may be described with reference to an example organization in the field of laboratory medicine which employs laboratory physicians to conduct different types of clinical work. As such:
the term ‘case’ is used analogously to the term ‘matter’ previously used herein;
the term ‘physician’ is used analogously to the term ‘worker’ previously used herein;
the term ‘WorkUnit’ is used analogously to the term ‘ruleset-assessed entry’ previously used herein.

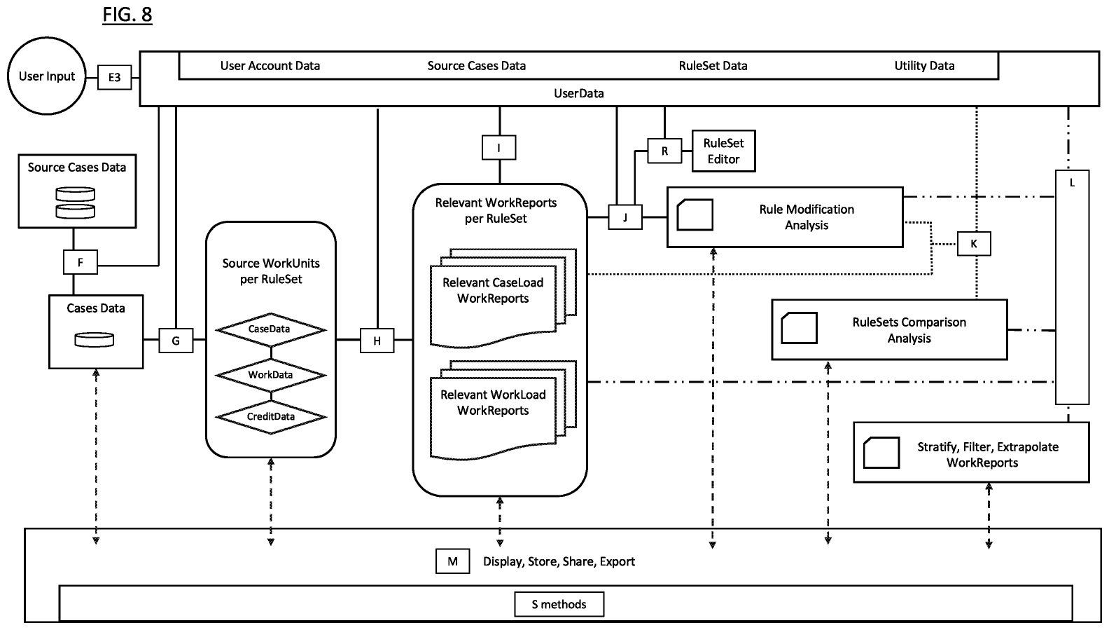

FIGS. 7 and 8 illustrate an overview of the variation of the method. The application, (which may be referred to as ‘App’ hereinafter and) which stores computer instructions for executing the method, provides all users, each of whom will have limited and varied abilities with regards to information technology, with an equitable level of access and insight into their workload measurements, and full control over how the results are displayed or shared with other users.

The App automates many of the necessary steps to turn raw data into user focused analytics.

Method block I (FIG. 8): this incorporates user data and determines automatically what results or analytics are appropriate for the user. These patent documents refer to all results and analytics as WorkReports. Relevant WorkReports are results that are relevant to the user. For example, a lab physician may want to view all of their own workload, both on cases that they've signed out (primary cases) but also on other physicians' cases (secondary cases). They may also want to see all the work done by other physicians on their cases (ie. Consults, biomarker reports). These distinctions are represented by the App using the terms WorkLoad, CaseLoad, Primary work (P1), Secondary work (S2), and Tertiary work (T3). These terms and this particular breakdown of results is automated and is standard throughout the App. The glossary provides a full definition.

However, in addition to their own personal results, some users may also want to see the results of other physicians. A site lead, for example, wants to view the results of each physician on site and also the group results. An administrator might want to see the results of multiple sites.

The App automates this process and determines which sets of results, or WorkReports, are appropriate or relevant for the user (Method Block I).

Once the Relevant WorkReports are determined, the App ‘fills’ in the WorkReports by analyzing the necessary source information (Method Block H) which looks at the Necessary WorkUnits generated by Method G.

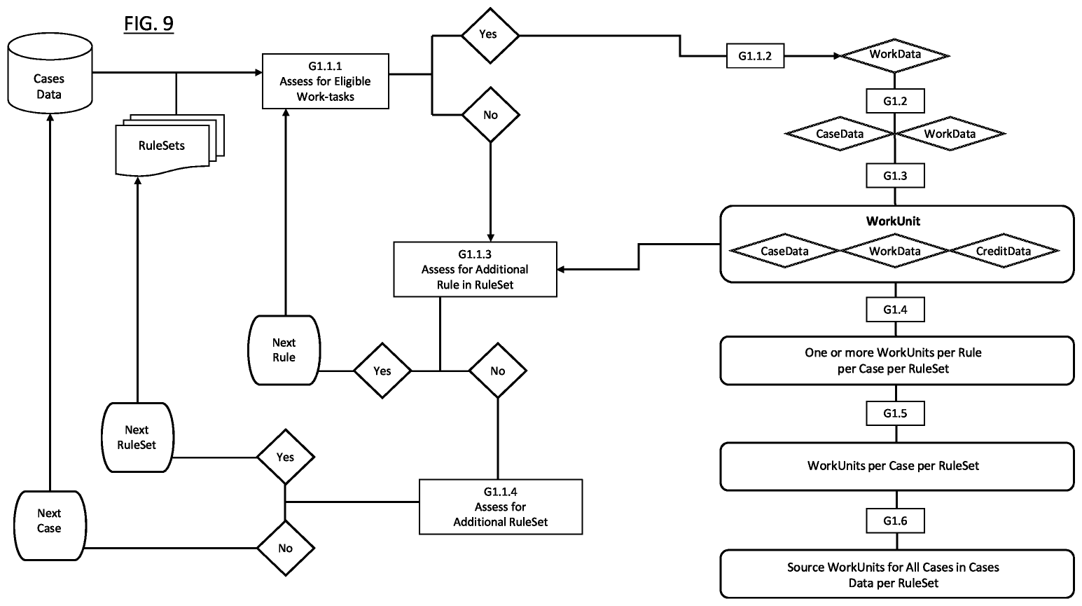

With reference to FIG. 9, the primary function of the App is to generate WorkUnits to analyze workload. A WorkUnit is a record of each discrete work-task, its assigned value, the case it belongs to, and the physician who performed the work. The database stores these WorkUnits as discrete entities, thus allowing the WorkUnits to be sorted very easily according to case type or physician or both. The business logic of the App also uses several code classes dedicated to the WorkUnit. It is central to all subsequent analyses.

The App turns the focus of workload measurement away from the case or the physician, and to each work-task, which is given a value, linked to its source case, and assigns and tracks credit to the physician who performed the work.

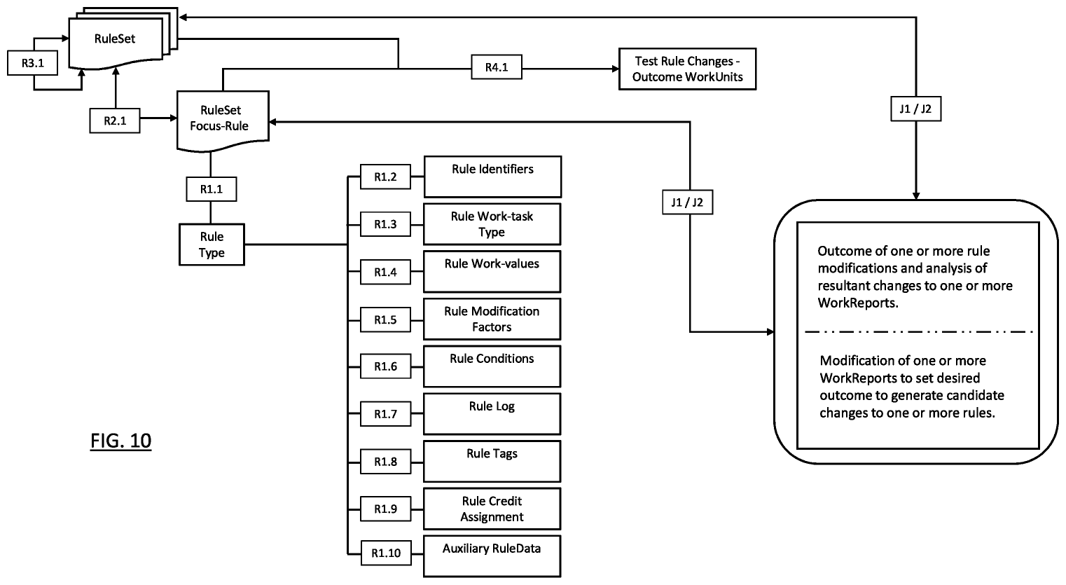

With reference to FIG. 10, the user may create or modify the Rules in a RuleSet. Rules R1.1 to R1.10 establish how the user can build or modify a rule.

Rule R1.3 is the step that matches the rule to the work-task which is identifiable in the case data. The App finds work-tasks in the case data in order to apply the corresponding work-values using the corresponding rules. R1.3 is the link between a work-task that is identified in the case data and the rule(s) that tell the App what to do with ‘that’ specific work-task.

The user can make one or more rule changes and then apply and analyze the impacts or outcomes of the changes or compare to pre-change results. OR, the user can also view the effects of the changes real-time. For example, the user may scroll through a list of work-values for a work-task and view the results of each change as it is made.

Alternatively, and as described in method sub-block J2, the user may change the WorkReport results to a desired outcome and allow the App to make one or more suggestions for rule changes that could affect the desired outcome. Basically, it is the reverse of changing a rule. Here, the user can change the result to a desired outcome and let the App provide a list of candidate rule(s) changes that the user could make in order to get the desired result.

Most lab physicians are paid a salary. With that salary comes a contracted number of days that they are required to work in a fiscal year.

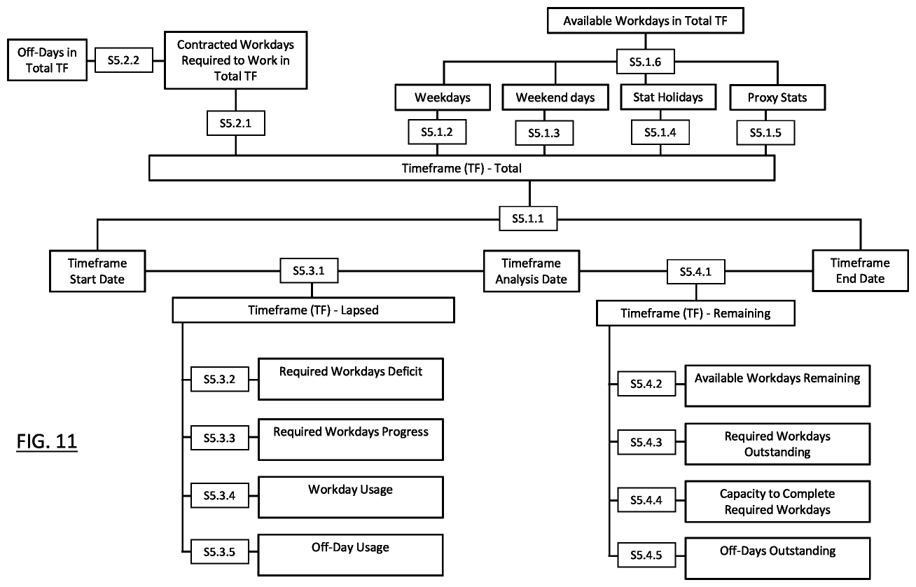

The steps in FIG. 11 calculate the number of days worked relative to the contracted number of days required to work and the number of days available to work. The App is configured to measure the number and type of days in a fiscal year (i.e., number of weekdays/workdays/weekend days/stat holidays). Thus, the user can set a start date and end date to define the fiscal year, and the analysis date could be set to the current date, for example. From there, the app uses the user's contract data (i.e., fulltime/part-time/number of days to work/number of days to do clinical service) to determine ‘progress’ and ‘remaining workdays available’ for the user with regards to fulfilling his/her contractual obligations.

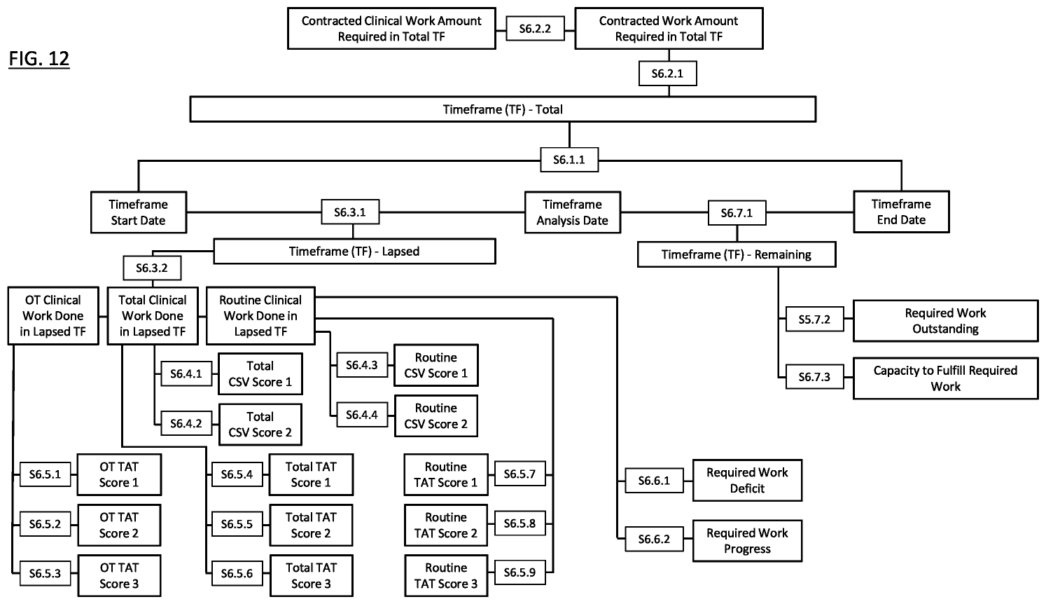

The steps in FIG. 12 are similar to FIG. 11 but calculate the numbers for workload instead of workdays. The steps in FIG. 12 also allow the user to distinguish routine work from over-time work and measure each separately.

Furthermore, the steps in FIG. 12 act to correlate workload to Turn-Around-Time (TAT; the time taken to finish the work). In short, it shows TATs but can correlate to workload and also normalize to workload. The App can present these complex analyses using a unique, single number score for easier interpretation and comparison, a TAT score.

The steps in FIG. 12 also generate an easy to interpret clinical service value (CSV) score. There are many variables in determining how much work a physician does, should do, and how much money a pathologist may be paid. The App can present these complex analyses using a unique, single number score for easier interpretation and comparison.

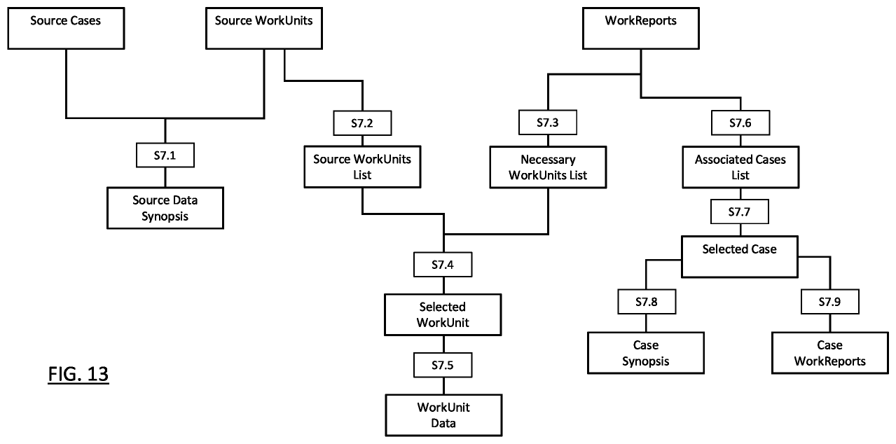

With reference to FIG. 13, the App is configured for transparency, that is to show the user the list of cases specifically used for the results being displayed in the WorkReport. If the results are filtered, then the case list is filtered accordingly.

Selecting a case from the list will show the user relevant case information, as well as the list of WorkUnits that were generated for the selected case. The details of each WorkUnit are also displayed to the user including the work-task type, work-value, date time stamps, who performed the work, and what rules were used to generate the WorkUnit. This is facilitated by Method Block G (FIG. 9).

The effect of this feature, that is transparency, is to remove the ‘black-box’ effect whereby users are presented analytics without really being able to understand, verify, or learn how the results were calculated.

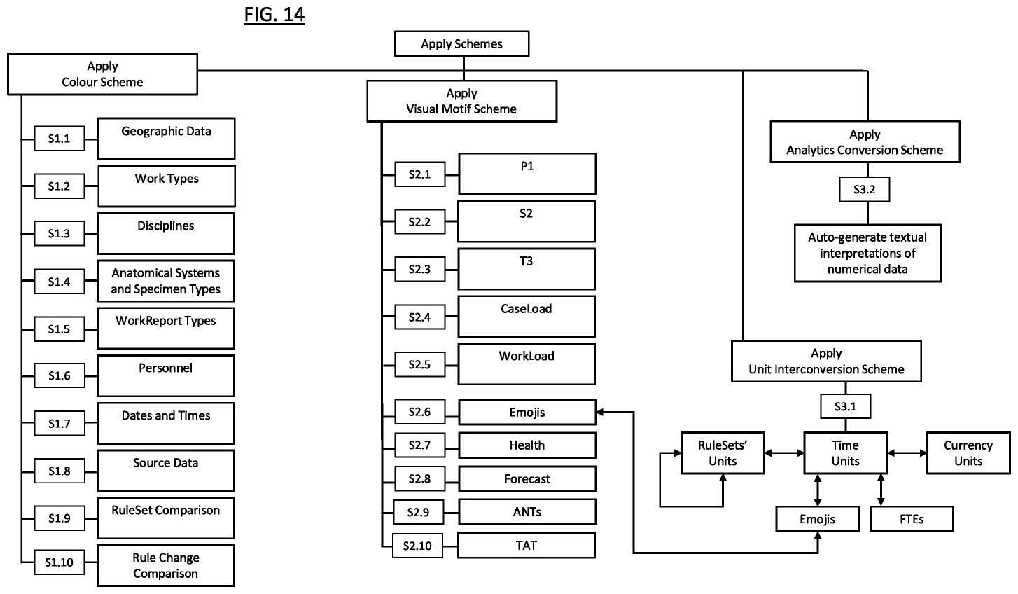

With reference to FIG. 14, all of the ‘S’ methods (S is for style) can be summed up as a ‘style’ of presenting the results or WorkReports to the user.

S1.1 to S1.10—applying colour schemes to different groups of results or analytics, as listed in the flowchart.

S2.1 to S2.10—using specific words, abbreviations, acronyms, or emoji's to represent groups of results or analytics, as listed in the flowchart.

S3.1—a method that simply converts the units of work measurement into another unit of measurement or to a common unit of time, FTE, or currency (or even an emoji). The different RuleSets, for example, may have different units of measurement. If RuleSet #1 uses ‘points’ to add value to work, the App can still convert the points value to the units of a second RuleSet that may use a different unit of measurement. This enables comparison of the results of different RuleSets (which would be meaningless if the results of two RuleSets were presented in different units of measurement).

S3.2—Auto-generate text interpretations of results. This converts numerical results or analytics into normal language text that lab physicians would better relate to and understand (in point form or full sentences, for example). It is a better way to provide feedback, forecasting, or recommendations etc.

Most case data is pulled from the Lab Information System (LIS). The data is imported and analyzed. This is considered passive. It does not require additional time and effort to enter data. The data is already entered into the LIS as a part of the normal workflow (i.e., Issuing reports, ordering tests etc.).

However, it is possible that not all work-tasks can be captured by the LIS. Thus, the App may optionally additionally be configured with a WorkRegister tool or functionality, which gives the user a place to ‘actively’ record or log their work. This is just a data-entry interface that is saved to a database. This WorkRegister contributes to the Source Cases Data (FIG. 7). The App may consider this data as well and incorporate it into the overall work measurement.

The user can create a case (real or simulated). For each case, the user can add work-tasks that he/she performed. The user can select from a list work-tasks. Alternatively, the user may choose to build a shadow report. That is, the user can create a pathology report, for example, that mimics an actual pathology report. The App can read the report just like it reads case data and show the user a list of WorkUnits that would be generated for the work-tasks that have been identified in the shadow report. The shadow report could be transferred to the LIS (i.e. copy and pasted). This allows the user to actively log one or all work-tasks associated with the case without making two reports.

The purpose of allowing users to create one or more simulated cases is to allow the user to create a batch of ‘not-yet-done’ cases to estimate the amount of work anticipated for a research study, for example, where the actual accrued cases are not yet known.

In summary, the WorkRegister could be used to actively log or record a portion of the work-tasks associated with a case. Or, it could be used to actively log the entire case and ALL work-tasks associated with the case. The user can select work-tasks from a list or build a shadow report.

The App may additionally optionally be configured with a WorkEstimator tool or functionality. This acts to identify work that is incomplete or anticipated research work (as opposed to looking at work that has already been completed). The WorkReports discussed earlier provide workload measurement for work that has already been completed. However, the App can also provide a work measurement for work that is incomplete or not-yet-done. Thus, it uses the same methods but applies them to incomplete work.

The App may additionally optionally be configured with a WorkInvoicer tool or functionality configured to convert WorkReports and WorkEstimates to currency values and auto-generate invoices. A WorkReport for the month of March, for example, could be compared to an established monthly maximum workload. If the measured workload for that timeframe exceeded the maximum level, an invoice for overtime could be generated automatically and distributed as necessary.

The App may additionally optionally be configured with a WorkMatch tool or functionality. For a bundle or batch of incomplete work, with a list of the work details, including an estimate of the work-value or work amount, the next step is preferably to find a physician to do the work. Typically, these are small, standalone batches of work performed outside of routine workflow. The two best examples are overtime and research work.

For such work, WorkMatch provides the ‘sender’ (such as a site lead who is responsible to distribute the work) with the ability to send out a request electronically—a text message (IM) for example—to eligible staff. The IM contains the work details and ask the recipients to respond (ie. Yes, no, maybe). The responses could be managed by the sender or could be completely automated. The receiver receives a confirmation or declination response. Basically, WorkMatch automates the distribution of small batches of work that do not fit into the normal work distribution system.

Referring back to FIG. 7, below is a summary of the blocks shown

| Function/Method | | | |
|---|---|---|---|
| Name | Group | Label | Method Function |
| User Identification | A | A1 | A method that may provide for the user to import, |
| Data | | | retrieve, or input User Identification Data. The data is |
| | | | integrated into the User Account Data of the |
| | | | UserData. User Identification Data may include, but is |
| | | | not limited to, names, usernames and passwords. |
| User Professional | A | A2 | A method that may provide for the user to import, |
| Data | | | retrieve, or input User Professional Data. The data is |
| | | | integrated into the User Account Data of the |
| | | | UserData. User Professional Data may include, but is |
| | | | not limited to, information that pertains to user |
| | | | employment or service contracts, user associated |
| | | | geographic locations or organizations, user rota or |
| | | | schedules, user rosters, user qualifications or |
| | | | disciplines, the user's work-task type repertoire, or the |
| | | | user's work-task repertoire. |
| | | | User employment or service contract information may |
| | | | include, but is not limited to, a relative or absolute |
| | | | required work amount, including but not limited to |
| | | | workdays, work hours, or other unit of time or |
| | | | measurement of work that is performed over the |
| | | | course of a specified or implied time span. The |
| | | | contract information may also provide for a |
| | | | proportional distribution of types of work including, but |
| | | | not limited to, clinical work that pertains to direct |
| | | | patient care, administrative work, teaching and |
| | | | training work, research work, and quality assurance |
| | | | and improvement work. |
| | | | User associated geographic locations or |
| | | | organizations may include, but are not limited to, |
| | | | countries, provinces, states, cities, counties, user |
| | | | defined zones or areas, institutions, collections sites, |
| | | | medical laboratories, departments, private entities, or |
| | | | hospitals. |
| | | | User rotas or schedule information may include, but is |
| | | | not limited to, information pertaining to the user's |
| | | | assigned work tasks in relation to a specific date or |
| | | | time or general time span. |
| | | | User roster information may include, but is not limited |
| | | | to, one or more lists of one or more laboratory |
| | | | physicians that are identified or recognized as having |
| | | | a common association, often used for the purposes |
| | | | of, but not limited to, assignment of work. |
| | | | User qualifications or discipline information may |
| | | | include, but is not limited to, information pertaining to |
| | | | the user's general or specific training in one or more |
| | | | disciplines in laboratory medicine. |
| | | | Information pertaining to the user's work-task |
| | | | repertoire may include, but is not limited to, one or |
| | | | more work-tasks that the user may perform. |
| User Permissions | A | A3 | A method that may provide for the user to import, |
| Data | | | retrieve, or input User Permissions Data. The data is |
| | | | integrated into the User Account Data of the |
| | | | UserData. User Permissions Data may include, but is |
| | | | not limited to, the identification of RuleSet Data, Raw |
| | | | Work Data, Conditioned Work Data, Sample Work |
| | | | Data, Source Cases Data, Cases Data, Source |
| | | | WorkUnits, or Relevant WorkReports to which the |
| | | | user is allowed or permitted to have access. |
| | | | Permissions data for a user may be determined by |
| | | | other users. |
| User Preference | A | A4 | A method that may provide for the user to import, |
| Data | | | retrieve, or input User Preference Data. The data is |
| | | | integrated into the User Account Data of the |
| | | | UserData. User Preference Data may include, but is |
| | | | not limited to, stylistic preferences that pertain to user |
| | | | interface elements or the integration of default values |
| | | | that pertain to one or more methods. |
| Source Cases Data | B | B1 | A method that may provide for the user to import, |
| | | | retrieve, or input Raw Work Data, Conditioned Work |
| | | | Data, or Sample Work Data. The information is |
| | | | integrated into the Source Cases Data of the |
| | | | UserData. |
| | | | Raw Work Data pertains to case information and any |
| | | | record of work performed by laboratory physicians. |
| | | | The information may include, but is not limited to, |
| | | | Laboratory Medical Reports or workflow tracking |
| | | | information including, but not limited to, records of |
| | | | cases and associated tissue specimens, tissue |
| | | | blocks, routine histological slides, ancillary |
| | | | histological tissue blocks or histological slides, routine |
| | | | ancillary tests, specialized ancillary tests, records of |
| | | | consultations, records of communications, records of |
| | | | quality assurance and improvement work, records of |
| | | | teaching and training, records of research work, |
| | | | records of administrative work, and any recorded |
| | | | information that one or more RuleSets may recognize |
| | | | as a work-task that may have an associated work- |
| | | | value. |
| | | | Sample Work Data may include, but is not limited to, |
| | | | code generated data or user inputted data that is |
| | | | representative of a data source that the user may wish |
| | | | to simulate. |
| Conditioned Work | B | B4 | A method that may provide for the user to analyse |
| Data | | | Raw Work Data and modify it into Conditioned Work |
| | | | Data. Conditioned Work Data may include, but is not |
| | | | limited to, information that has been validated for data |
| | | | type quality, data accuracy, and data completeness. |
| | | | Incorrect data types may be corrected. Inaccurate or |
| | | | incomplete data may be substituted with one or more |
| | | | placeholder or default values from one or more digital |
| | | | files or user inputted data. |
| RuleSet Data - App | C | C1 | A method that may provide for the user to use one or |
| Based RuleSets | | | more app-based RuleSets. The method that may |
| | | | provide for the user to edit or delete one or more app- |
| | | | based RuleSets using the Ruleset Editor. The data is |
| | | | integrated into the RuleSet Data of the UserData. |
| RuleSet Data - | C | C2 | A method that may provide for the user to use one or |
| Imported RuleSets | | | more imported RuleSets. The method that may |
| | | | provide for the user to import, edit, or delete one or |
| | | | more imported RuleSets using the Ruleset Editor. The |
| | | | data is integrated into the RuleSet Data of the |
| | | | UserData. |
| RuleSet Data - | C | C3 | A method that may provide for the user to use one or |
| Shared User | | | more shared RuleSets. The method that may provide |
| RuleSets | | | for the user to edit or delete one or more shared |
| | | | RuleSets using the Ruleset Editor. The data is |
| | | | integrated into the RuleSet Data of the UserData. |
| RuleSet Data - | C | C4 | A method that may provide for the user to use one or |
| Custom User | | | more custom RuleSets. The method that may provide |
| RuleSets | | | for the user to build, edit, or delete one or more |
| | | | custom RuleSets using the Ruleset Editor. The data |
| | | | is integrated into the RuleSet Data of the UserData. |
| Personnel Data | D | D1 | A method that may provide for the user to import, |
| | | | retrieve, or input Personnel Data. The data is |
| | | | integrated into the Utility Data of the UserData. |
| | | | Personnel Data may include, but is not limited to, |
| | | | laboratory physician names and other identification |
| | | | information and professional information including, |
| | | | but not limited to, specialized area of practice and |
| | | | organization affiliations. |
| Anatomical Systems | D | D2 | A method that may provide for the user to import, |
| and Tissue | | | retrieve, or input Anatomical Systems and Tissue |
| Specimens Data | | | Specimens Data. The data is integrated into the Utility |
| | | | Data of the UserData. Anatomical Systems and |
| | | | Tissue Specimens Data may include, but is not limited |
| | | | to, autopsy, breast, cardiovascular, cytology, |
| | | | endocrine, eye, gynecological, head and neck, |
| | | | hematopathology, neurological, musculoskeletal and |
| | | | soft tissue, lung, skin, urogenital, hepatobiliary, |
| | | | gastrointestinal, renal, perinatal, and pediatric |
| | | | systems, each with associated, respective tissue |
| | | | specimen types. |
| Organization Data | D | D3 | A method that may provide for the user to import, |
| | | | retrieve, or input Organization Data. The data is |
| | | | integrated into the Utility Data of the UserData. |
| | | | Organization Data may include, but is not limited to, |
| | | | information pertaining to academic institutions, |
| | | | laboratory departments, government institutions, or |
| | | | private entities |
| Geographic Data | D | D4 | A method that may provide for the user to import, |
| | | | retrieve, or input Geographic Data. The data is |
| | | | integrated into the Utility Data of the UserData. |
| | | | Geographic Data may include, but is not limited to, |
| | | | countries, provinces, states, cities, counties, user |
| | | | defined zones or areas, collections sites, medical |
| | | | laboratories, departments, or hospitals. |
| Roster Data | D | D5 | A method that may provide for the user to import, |
| | | | retrieve, or input Roster Data. The data is integrated |
| | | | into the Utility Data of the UserData. Roster Data may |
| | | | include, but is not limited to, groups of one or more |
| | | | laboratory physicians. |
| Calendar and Fiscal | D | D6 | A method that may provide for the user to import, |
| Year Data | | | retrieve, or input Calendar and Fiscal Year Data. The |
| | | | data is integrated into the Utility Data of the UserData. |
| | | | Fiscal Year Data may include, but is not limited to, |
| | | | calendar years, fiscal years, months of the year, |
| | | | weeks of the year, days or the year, statutory |
| | | | holidays, weekend days, workdays, days of the |
| | | | month, days of the week, days of the year, start dates, |
| | | | end dates, or turn around times. |
| Discipline Data | D | D7 | A method that may provide for the user to import, |
| | | | retrieve, or input Discipline Data. The data is |
| | | | integrated into the Utility Data of the UserData. |
| | | | Discipline Data may include, but is not limited to, |
| | | | pathologists, anatomical pathologists, general |
| | | | pathologists, cytopathologists, medical examiners, |
| | | | autopsy pathologists, hematopathologists, molecular |
| | | | pathologists, surgical pathologists, transusion |
| | | | medicine specialists, medical microbiologists. |
| Auxiliary Data | D | D8 | A method that may provide for the user to import, |
| | | | retrieve, or input any additional, custom Auxiliary Data |
| | | | that the user determines is necessary or useful in the |
| | | | analysis of work done by laboratory physicians. The |
| | | | Auxiliary Data may be sorted into one or more user |
| | | | defined custom groups. The user may establish one |
| | | | or more relationships between Auxiliary Data and |
| | | | other UserData data groups. The Auxiliary Data is |
| | | | integrated into the Utility Data of the UserData. |
| User Login | E | E1 | A method that may provide for the user to input User |
| | | | Identification Data for the purpose of logging into the |
| | | | App. |
| Manage UserData | E | E2 | A method that may provide for the user to modify, add, |
| | | | sort, delete, arrange, aggregate, integrate, stratify, or |
| | | | filter UserData. The method may also store UserData |
| | | | for subsequent use. |
| User Input | E | E3 | A method that may provide for the user to input |
| | | | information that may be used in the processing or |
| | | | analysis of Source Data or for the reporting, |
| | | | stratifying, filtering, or extrapolation of relative |
| | | | analytics and may store one or more user inputs for |
| | | | subsequent use. |

Referring back to FIG. 8, below is a summary of the blocks shown therein:

| Function/Method | | | |
|---|---|---|---|
| Name | Group | Label | Method Function |
| Generate Source | F | F1 | Using UserData, a method that may sort, aggregate, |
| Cases Data | | | integrate, and arrange Source Cases Data into a |
| | | | unified collection of a case-based data set (Cases |
| | | | Data). Cases Data represents a central repository of |
| | | | data per case that may derive from one or more |
| | | | sources. Cases Data may derive from discrete data |
| | | | fields or be parsed from non-discrete data fields. The |
| | | | method may also retrieve existing, relative Cases |
| | | | Data that were previously generated and stored. |
| Generate WorkUnits | G | G1 | Using UserData, a method that may apply the |
| | | | RuleData for each rule from each RuleSet to each |
| | | | work-task in each case in Cases Data. |
| | | | A RuleSet comprises one or more rules. |
| | | | A rule is a method that represents one or more |
| | | | instructions that determine the value of a task. The |
| | | | function of the method is to generate one or more |
| | | | WorkUnits per work-task in each case. The |
| | | | WorkUnits generated by the method depend on the |
| | | | case data and the RuleData. |
| | | | RuleData comprises one or more parameters. Rule |
| | | | parameters may include, but are not limited to, one |
| | | | or more work-task types, one or more work-values, |
| | | | one or more relevant case data parameters derived |
| | | | from one or more case attributes and corresponding |
| | | | case values, one or more modifiers, one or more |
| | | | conditions, or one or more actions. |
| | | | The purpose of the WorkUnit is to assign one or more |
| | | | work-values to one or more work-tasks of each case |
| | | | and ensure the credit for any work-value or proportion |
| | | | of work-value is assigned to the appropriate Credit |
| | | | Physician. |
| | | | A Credit Physician is the Laboratory Physician who |
| | | | performed the work. |
| | | | In constructing the WorkUnits, the method uses case |
| | | | data and RuleData to generate the resultant |
| | | | WorkData. WorkData includes, but is not limited to, |
| | | | the type of work done including one or more |
| | | | categories of work, a base work-value, a quantity |
| | | | value, a total work-value, a record of the instructions |
| | | | or rules used to generate the work value, a record of |
| | | | instructions that may by used for further modifications |
| | | | of the work value to be used in subsequent analyses, |
| | | | as well as, date, time, and timespan records |
| | | | associated with the work-task. |
| | | | In summary, each WorkUnit represents one or more |
| | | | work-values assigned to one or more work-tasks |
| | | | derived from a case. Each work-value is accredited |
| | | | to one or more Credit Physicians. For each discrete |
| | | | work-task, the method establishes the link between |
| | | | the information associated with the source case |
| | | | (CaseData) to the personnel data associated with |
| | | | one or more Credit Physicians (CreditData), as well |
| | | | as the information associated with the work-task itself |
| | | | (WorkData). Collectively, the CaseData, CreditData, |
| | | | and WorkData form the WorkUnitData of each |
| | | | WorkUnit. The WorkUnitData links the necessary |
| | | | information for subsequent analysis in Relevant |
| | | | WorkReports. |
| | | | Collectively, the WorkUnits form the Source |
| | | | WorkUnits. |
| | | | The method may also retrieve existing, relative |
| | | | WorkUnits that were previously generated or stored. |
| Sort Necessary | H | H1 | Using UserData, a method that may analyze the |
| WorkUnits Lists | | | WorkUnitData from the Source WorkUnits to |
| | | | generate a list of Necessary WorkUnits for each |
| | | | Relevant WorkReport. The method may also retrieve |
| | | | existing, relative Necessary WorkUnits that were |
| | | | previously generated and stored for each Relevant |
| | | | WorkReport. |
| Generate Relevant | I | I1 | Using UserData, a method that may generate one or |
| WorkReports | | | more Relevant WorkReports for one or more |
| | | | RuleSets. The method may also retrieve existing |
| | | | Relevant WorkReports per RuleSet that were |
| | | | previously generated and stored. A WorkReport |
| | | | represents the results of an analysis of one or more |
| | | | WorkUnits. A Relevant WorkReport represents the |
| | | | the analytics of one or more WorkUnits that are |
| | | | filtered according to one or more UserData |
| | | | parameters. |
| | | | The method may stratify one or more Relevant |
| | | | WorkReports into one or more Relevant CaseLoad |
| | | | WorkReports for one or more WorkUnits that pertain |
| | | | to one or more cases or groups of cases. |
| | | | The method may stratify one or more Relevant |
| | | | WorkReports into one or more Relevant WorkLoad |
| | | | WorkReports for one or more WorkUnits that pertain |
| | | | to one or more Laboratory Physicians or groups of |
| | | | Laboratory Physicians. |
| | | | The method may stratify one or more Relevant |
| | | | CaseLoad WorkReports into one or more |
| | | | WorkReports that pertain to work performed on one |
| | | | or more cases by the primary laboratory physician, |
| | | | when such a distinction may be determined (Primary |
| | | | CaseLoad WorkReports). The method may stratify |
| | | | one or more Relevant CaseLoad WorkReports into |
| | | | one or more WorkReports that pertain to work |
| | | | performed on one or more cases by one or more |
| | | | secondary laboratory physicians, when such a |
| | | | distinction may be determined (Tertiary CaseLoad |
| | | | WorkReports). A primary laboratory physician is the |
| | | | laboratory physician considered to be primarily |
| | | | responsible for the case. A secondary laboratory |
| | | | physician is not considered to be primarily |
| | | | responsible for the case. |
| | | | The method may stratify one or more Relevant |
| | | | WorkLoad WorkReports into one or more |
| | | | WorkReports that pertain to work performed by one |
| | | | or more laboratory physicians on one or more primary |
| | | | cases, when such a distinction may be determined |
| | | | (Primary WorkLoad WorkReports). The method may |
| | | | stratify one or more Relevant WorkLoad |
| | | | WorkReports into one or more WorkReports that |
| | | | pertain to work performed by one or more laboratory |
| | | | physicians on one or more secondary cases, when |
| | | | such a distinction may be determined (Secondary |
| | | | WorkLoad WorkReports). A primary case is a case |
| | | | that a laboratory physician is considered to be |
| | | | primarily responsible for the case. A secondary case |
| | | | is a case that a laboratory physician is not considered |
| | | | to be primarily responsible for the case. |
| WMS RuleSet | J | J1 | Using UserData and RuleSet Editor, a method that |
| Modification | | | may allow the user to select one or more RuleSets to |
| Analysis | | | apply one or more changes to one or more RuleSets' |
| | | | Rules. The method may generate a comparative |
| | | | analysis of the respective Relevant WorkReports to |
| | | | assess the outcome or impact of the user applied rule |
| | | | changes. The method may juxtapose the RuleSet |
| | | | Editor and the Relevant WorkReports user interfaces |
| | | | to allow the user to visualize the impact of any |
| | | | change as it is made. The method may also retrieve |
| | | | existing, relative analytics that were previously |
| | | | generated and stored. |
| Rule Change | J | J2 | Alternatively, using UserData and RuleSet Editor, a |
| Recommendations | | | method that may allow the user to apply one or more |
| | | | changes to one or more Relevant WorkReports |
| | | | results in order to set the desired outcome. Based on |
| | | | the user defined outcome, the method may generate |
| | | | one or more RuleData candidate changes that may |
| | | | affect or closely affect the desired outcome. The |
| | | | method may allow the user to visualize, modify, and |
| | | | save one or more of the generated rule changes. |
| RuleEditor | R | R | Using UserData, a method that may provide for the |
| | | | user to modify one or more rules and one or more |
| | | | RuleSets. The method may provide for the user to |
| | | | evaluate the outcome or results of the changes. |
| RuleSets | K | K1 | Using UserData, a method that may provide for the |
| Comparison Analysis | | | user to select more than one RuleSet and generate |
| | | | Relevant WorkReports for two or more RuleSets with |
| | | | or without user defined modifications per method J1. |
| | | | The method may juxtapose the WorkReports to |
| | | | compare two or more RuleSets with or without any |
| | | | user defined modifications. The method may also |
| | | | retrieve existing, relative analytics that were |
| | | | previously generated and stored. |
| Stratify, Filter, | L | L1 | Using UserData, a method that may stratify, filter, or |
| Extrapolate | | | extrapolate one or more available WorkReports using |
| WorkReports | | | parameters that are associated with the |
| | | | WorkUnitData of the WorkUnits in each |
| | | | WorkReport's list of Necessary WorkUnits. |
| | | | Available WorkReports may include, but are not |
| | | | limited to, Relevant WorkReports, Relevant |
| | | | CaseLoad WorkReports, Relevant WorkLoad |
| | | | WorkReports, Relevant Primary WorkLoad |
| | | | WorkReports, Relevant Secondary WorkLoad |
| | | | WorkReports, Relevant Primary CaseLoad |
| | | | WorkReports, or Relevant Tertiary CaseLoad |
| | | | WorkReports. The method may allow the user to |
| | | | customize the filter parameters or the stratification |
| | | | and extrapolation parameters or preferences. The |
| | | | method may also retrieve existing, relative analytics |
| | | | that were previously generated and stored. |
| Display, Store, | M | M1 | Using UserData, a method that may display, store, |
| Share, Export | | | share, or export the analytics generated by methods |
| | | | F1, G1, H1, I1, J1, K1, or L1 onto one or more local, |
| | | | network, or cloud-based devices. |

Referring back to FIG. 9, below is a summary of the blocks shown therein:

| Function/Method | | | |
|---|---|---|---|
| Name | Group | Label | Method Function |
| Work-task | G | G1.1.1 | Using UserData and RuleData, a method that may |
| Assessment | | | determine if there is one or more eligible work-tasks |
| | | | for each rule in each RuleSet for each case in Cases |
| | | | Data. |
| WorkData | G | G1.1.2 | Using UserData, a method that may apply the |
| | | | RuleData for each rule to each work-task determined |
| | | | by method G1.1.1. Using the RuleData, the method |
| | | | may generate one or more WorkData for each of one |
| | | | or more work-tasks. |
| CaseData- | G | G1.2 | Using UserData, a method that may link the relevant |
| WorkData Link | | | CaseData of the current case to each WorkData |
| | | | generated in method G1.1.2. |
| Assign CreditData | G | G1.3 | Using UserData, a method that may link the |
| | | | CreditData of one or more credit physicians to each |
| | | | CaseData-WorkData link from method G1.2 to form |
| | | | the WorkUnit Data of each WorkUnit. The CreditData |
| | | | includes the information pertaining to a Credit |
| | | | Physician, who is the Laboratory Physician who |
| | | | performed the work. |
| Assess Next Rule in | G | G1.1.3 | Using UserData, a method that may determine if there |
| RuleSet | | | is another rule in the current RuleSet to apply to the |
| | | | current case data. |
| Assess Next | G | G1.1.4 | Using UserData, a method that may determine if there |
| RuleSet | | | is another RuleSet to apply to the current case data. |
| WorkUnits Per Rule | G | G1.4 | Using UserData, a method that may aggregate the |
| Per Case Per | | | WorkUnits per rule per case per RuleSet into one or |
| RuleSet | | | more groups of WorkUnits. |
| WorkUnits Per Case | G | G1.5 | Using UserData, a method that may aggregate all |
| Per RuleSet | | | WorkUnits per case per RuleSet into one or more |
| | | | groups of WorkUnits. |
| Source WorkUnits | G | G1.6 | Using UserData, a method that may aggregate all |
| for All Cases in | | | WorkUnits for all cases in Cases Data per RuleSet |
| Cases Data Per | | | into one or more groups of Source WorkUnits for |
| RuleSet | | | subsequent analysis and reporting in Relevant |
| | | | WorkReports. |

Referring back to FIG. 10, below is a summary of the blocks shown therein:

| Function/Method | | | |
|---|---|---|---|
| Name | Group | Label | Method Function |
| Ruledata - Rule- | R | R1.1 | Using UserData, a method that may provide for the |
| type | | | user to select from a list or unput a rule-type that may |
| | | | be assigned to RuleData of the focus-rule. The |
| | | | method may use case data attributes. The method |
| | | | may use case data values. |
| RuleData - Rule | R | R1.2 | Using UserData, a method that may provide for the |
| Identifiers | | | user to select from a list or input one or more rule |
| | | | identifiers that may be assigned to RuleData of the |
| | | | focus-rule. The method may use case data attributes. |
| | | | The method may use case data values. |
| RuleData - Rule | R | R1.3 | Using UserData, a method that may provide for the |
| Work-task Type | | | user to select from a list or input one or more rule work- |
| | | | task types that may be assigned to RuleData of the |
| | | | focus-rule. The method may use case data attributes. |
| | | | The method may use case data values. |
| RuleData - Rule | R | R1.4 | Using UserData, a method that may provide for the |
| Work-values | | | user to select from a list or input one or more rule work- |
| | | | values that may be assigned to RuleData of the focus- |
| | | | rule. The method may use case data attributes. The |
| | | | method may use case data values. |
| RuleData - Rule | R | R1.5 | Using UserData, a method that may provide for the |
| Modification Factors | | | user to select from a list or input one or more rule |
| | | | modification factors that may be assigned to RuleData |
| | | | of the focus-rule. The method may use case data |
| | | | attributes. The method may use case data values. A |
| | | | rule modification factor may adjust or modify one or |
| | | | more rule work-values. |
| RuleData - Rule | R | R1.6 | Using UserData, a method that may provide for the |
| Conditions | | | user to select from a list or input one or more rule |
| | | | conditions that may be assigned to RuleData of the |
| | | | focus-rule. The method may use case data attributes. |
| | | | The method may use case data values. A rule |
| | | | condition may be used for evaluation to determine the |
| | | | action or outcome of a rule. |
| RuleData - Rule Log | R | R1.7 | Using UserData, a method that may provide for the |
| | | | user to determine whether a record of the rule |
| | | | application and subsequent WorkUnit generation will |
| | | | be logged. The method may provide the user with one |
| | | | or more lists of one or more RuleData elements. The |
| | | | method may provide for the user to select one or more |
| | | | RuleData elements to record in the rule log. |
| RuleData - Rule | R | R1.8 | Using UserData, a method that may provide for the |
| Tags | | | user to select from a list or input one or more rule tags |
| | | | or labels. Rule tags may be used for subsequent |
| | | | analysis or result stratification. |
| RuleData - Rule | R | R1.9 | Using UserData, a method that may provide for the |
| Credit Assignment | | | user to select from a list one or more options to |
| | | | determine proportional credit assignment for the |
| | | | resultant WorkUnit to one or more credit physicians. |
| RuleData - Auxiliary | R | R1.10 | Using UserData, a method that may provide for the |
| RuleData | | | user to select from a list or input one or more data |
| | | | values to assign to the RuleData. |
| Manage RuleSet | R | R2.1 | Using UserData, a method that may provide for the |
| Rule | | | user to select a rule from one or more RuleSets. The |
| | | | method may establish the selected rule as the RuleSet |
| | | | focus-rule. The method may provide for the user to |
| | | | modify or delete the RuleSet focus-rule. Alternatively, |
| | | | the method may provide for the user to create one or |
| | | | more new rules. The method may establish a new rule |
| | | | as the RuleSet focus-rule. The method may provide |
| | | | for the user to assign a new rule to one or more |
| | | | RuleSets. The method may provide for the user to use |
| | | | one or more rules as a template to create one or more |
| | | | new rules. The method may provide for the user to |
| | | | save new or modified rules. The method may provide |
| | | | for the user to save one or more versions of each rule. |
| Manage RuleSets | R | R3.1 | Using UserData, a method that may provide for the |
| | | | user to create, modify, or delete one or more RuleSets. |
| | | | The method may provide for the user to use one or |
| | | | more RuleSets as a template to create one or more |
| | | | new RuleSets. The method may provide for the user |
| | | | to save new or modified RuleSets. The method may |
| | | | provide for the user to save one or more versions of |
| | | | each RuleSet. |
| Test RuleSets and | R | R4.1 | Using UserData, a method that may provide for the |
| Rules | | | user to select one or more RuleSets or one or more |
| | | | RuleSet rules to test. The method may apply one or |
| | | | more selected rules from one or more selected |
| | | | RuleSets to real or test data to produce one or more |
| | | | outcome WorkUnits. The method may provide for the |
| | | | user to visualize, store, share, or export one or more |
| | | | resultant outcome WorkUnits. The method may |
| | | | import, retrieve, or generate test data or sample data |
| | | | that may simulate real data. |
| WMS RuleSet | J | J1 | Using UserData and RuleSet Editor, a method that |
| Modification | | | may allow the user to select one or more RuleSets to |
| Analysis | | | apply one or more changes to one or more RuleSets' |
| | | | Rules. The method may generate a comparative |
| | | | analysis of the respective Relevant WorkReports to |
| | | | assess the outcome or impact of the user applied rule |
| | | | changes. The method may juxtapose the RuleSet |
| | | | Editor and the Relevant WorkReports user interfaces |
| | | | to allow the user to visualize the impact of any change |
| | | | as it is made. The method may also retrieve existing, |
| | | | relative analytics that were previously generated and |
| | | | stored. |
| Rule Change | J | J2 | Alternatively, using UserData and RuleSet Editor, a |
| Recommendations | | | method that may allow the user to apply one or more |
| | | | changes to one or more Relevant WorkReports results |
| | | | in order to set the desired outcome. Based on the user |
| | | | defined outcome, the method may generate one or |
| | | | more RuleData candidate changes that may affect or |
| | | | closely affect the desired outcome. The method may |
| | | | allow the user to visualize, modify, and save one or |
| | | | more of the generated rule changes. |

Referring back to FIG. 11, below is a summary of the blocks shown therein:

| Function/Method | | | |
|---|---|---|---|
| Name | Group | Label | Method Function |
| Total Timeframe | S | S5.1.1 | A method that may calculate the total timespan, or |
| (TF) | | | total timeframe (TF), between the TF start date and |
| | | | the TF end date. |
| Weekdays in Total | S | S5.1.2 | A method that may calculate the number of weekdays |
| TF | | | within the total TF. |
| Weekend Days in | S | S5.1.3 | A method that may calculate the number of weekend |
| Total TF | | | days within the total TF. |
| Statutory Holidays | S | S5.1.4 | A method that may calculate the number of statutory |
| in Total TF | | | holidays within the total TF. The method determines |
| | | | the day of the week of each holiday. If the holiday |
| | | | resides on a weekend day, the method will calculate |
| | | | the proxy statutory holiday. |
| Proxy Stat Holidays | S | S5.1.5 | A method that may calculate the number of proxy |
| in Total TF | | | statutory holidays within the total TF. A proxy statutory |
| | | | holiday is a weekday that acts as a substitute holiday |
| | | | when the statutory holiday corresponds to a weekend |
| | | | day. |
| Workdays in Total | S | S5.1.6 | A method that may that calculate the number of |
| TF | | | workdays that are available to work within the total TF. |
| | | | The number of workdays may be calculated by: |
| | | | [number of weekdays in the total TF] − [number of |
| | | | weekday statutory holidays in the total TF] − [number |
| | | | of proxy statutory holidays in the total TF]. |
| Contracted | S | S5.2.1 | Using UserData, a method that may calculate the |
| Required Workdays | | | target number of workdays that one or more lab |
| to Work in Total TF | | | physicians or groups of lab physicians are required to |
| | | | work by contract within the total TF. |
| Off-days in Total TF | S | S5.2.2 | A method that may calculate the target number of |
| | | | required off-days for one or more lab physicians or |
| | | | groups of lab physicians within the total TF. Off-days |
| | | | may be calculated by: [number of available workdays |
| | | | in total TF] − [contracted workdays required to work in |
| | | | total TF]. |
| Lapsed Timeframe | S | S5.3.1 | A method that may calculate the lapsed timespan, or |
| | | | lapsed timeframe (TF), between the TF start date and |
| | | | the analysis date selected by the user. The analysis |
| | | | date may be the current date or other date between |
| | | | the total TF start date and total TF end date. |
| Workdays Deficit | S | S5.3.2 | Using UserData, a method that may calculate the |
| | | | number of workdays deficient of the contracted |
| | | | number of required workdays. The deficit or surplus of |
| | | | workdays may be calculated by: [0] − [contracted |
| | | | workdays required to work in total TF] − [days worked |
| | | | in the lapsed TF]. The number workdays worked may |
| | | | derive from UserData or may be determined by |
| | | | analysis of WorkUnits. |
| Contract Progress | S | S5.3.3 | Using UserData, a method that may calculate the |
| | | | contract progress as a ratio of workdays worked in the |
| | | | lapsed TF to the workdays required to work in the total |
| | | | TF. The ratio may be calculated by: ([workdays |
| | | | worked in lapsed TF]/[contracted workdays required |
| | | | to work in total TFI) * [constant]. Alternatively, the |
| | | | progress may be presented as a ratio of deficit |
| | | | workdays in the lapsed TF to the workdays required to |
| | | | work in the total TF, calculated by: ([workday deficit in |
| | | | lapsed TF]/[contracted workdays required to work in |
| | | | total TF]) * [constant]. |
| Workday Usage | S | S5.3.4 | Using UserData, a method that may calculate the |
| | | | workday usage as a ratio of workdays worked in the |
| | | | lapsed TF to all workdays available to work in the |
| | | | lapsed TF. The ratio may be calculated by: ([workdays |
| | | | worked in lapsed TF]/[workdays available to work in |
| | | | lapsed TF]) * [constant]. The number of lapsed |
| | | | workdays may be calculated by: [number of weekdays |
| | | | in the lapsed TF] − [number of weekday statutory |
| | | | holidays in the lapsed TF] − [number of proxy statutory |
| | | | holidays in the lapsed TF]. |
| Off-day Usage | S | S5.3.5 | Using UserData, a method that may calculate the off- |
| | | | day usage as a ratio of off-days in the lapsed TF to all |
| | | | off-days available in the total TF. The ratio is |
| | | | calculated by: ([off-days in lapsed TF]/[off-days in |
| | | | total TF]) * [constant]. Off-days in lapsed TF may be |
| | | | calculated by: [number of available workdays in lapsed |
| | | | TF] − [number of workdays worked in lapsed TF]. |
| Remaing | S | S5.4.1 | A method that may calculate the remaining timespan, |
| Timeframe | | | or remaining timeframe (TF), between the analysis |
| | | | date selected by the user and the TF end date. The |
| | | | analysis date may be the current date or other date |
| | | | between the total TF start date and total TF end date. |
| Available Workdays | S | S5.4.2 | A method that may that calculate the number of |
| Remaining | | | remaining workdays that are available to work within |
| | | | the remaining TF. The number of remaining workdays |
| | | | may be calculated by: [number of weekdays in the |
| | | | remaining TF] − [number of weekday statutory holidays |
| | | | in the remaining TF] − [number of proxy statutory |
| | | | holidays in the remaining TF1. |
| Outstanding | S | S5.4.3 | Using UserData, a method that may calculate the |
| Workdays | | | outstanding number of workdays that are still required |
| | | | to work in the remaining TF to satisfy the required |
| | | | contracted workdays for the total TF. The outstanding |
| | | | workdays may be calculated by: [0] − [workdays |
| | | | deficit]. The workdays deficit is derived from S5.3.2. |
| | | | Alternatively, the outstanding workdays may be |
| | | | presented as a proportion of the contracted required |
| | | | workdays calculated by: [workdays deficit]/ |
| | | | [contracted workdays required to work in total TF] * |
| | | | [constant]. |
| Capacity to | S | S5.4.4 | Using UserData, a method that may calculate the |
| Complete | | | capacity to fulfill the contracted required workdays. |
| Contracted | | | The capacity may be calculated by: [available |
| Required Workdays | | | workdays in remaining TF] − [outstanding workdays]. |
| | | | Alternatively, the capacity may be calculated by: |
| | | | [outstanding workdays]/[available workdays in |
| | | | remaining TF] * [constant]. |
| Off-days Remaining | S | S5.4.5 | Using UserData, a method that may calculate the |
| | | | outstanding off-days in the remaining TF calculated |
| | | | by: [off-days in Total TF] − [off-days in lapsed TF]. |

Referring back to FIG. 12, below is a summary of the blocks shown therein:

| Function/Method | | | |
|---|---|---|---|
| Name | Group | Label | Method Function |
| Total Timeframe | S | S6.1.1 | A method that may calculate the total timespan, or |
| (TF) | | | total timeframe (TF), between the TF start date and |
| | | | the TF end date. |
| Contracted | S | S6.2.1 | Using UserData, a method that may calculate the |
| Required Work | | | target amount of work that one or more lab physicians |
| Amount Required in | | | or groups of lab physicians are required to work by |
| Total TF | | | contract within the total TF. |
| Contracted Clinical | S | S6.2.2 | A method that may calculate the proportion contracted |
| Work Amount | | | work amount (from S6.2.1) that is allocated for clinical |
| Required in Total TF | | | service work. The proportion may be calculated by: |
| | | | [contracted work amount in total TF] * [clinical service |
| | | | rate]. |
| Lapsed Timeframe | S | S6.3.1 | A method that may calculate the lapsed timespan, or |
| | | | lapsed timeframe (TF), between the TF start date and |
| | | | the analysis date selected by the user. The analysis |
| | | | date may be the current date or other date between |
| | | | the total TF start date and total TF end date. |
| Work Done in | S | S6.3.2 | A method that may group clinical work done in the |
| Lapsed Time | | | lapsed TF into three groups. OT clinical work is |
| | | | overtime work and represents work done in addition to |
| | | | contracted work amounts. Routine clinical work |
| | | | represents contracted work amounts. Total clinical |
| | | | work is the sum of overtime clinical work and routine |
| | | | clinical work. |
| Total CSV Score 1 | S | S6.4.1 | A method that may generate a total clinical service |
| | | | value (CSV) score for total clinical work done in the |
| | | | lapsed TF. The score may be calculated by: [total |
| | | | clinical work]/[total remuneration] * [constant]. Total |
| | | | remuneration may be calculated by: [routine |
| | | | remuneration] + [overtime remuneration]. |
| Total CSV Score 2 | S | S6.4.2 | A method that may generate a total clinical service |
| | | | value (CSV) score for total clinical work done in the |
| | | | lapsed TF that is adjusted for the proportion of |
| | | | contracted clinical work amount required. The score |
| | | | may be calculated by: [total clinical work]/([routine |
| | | | remuneration] * [effective clinical service rate] + |
| | | | [overtime remuneration]) * [constant]. |
| Routine CSV Score | S | S6.4.3 | A method that may generate a routine clinical service |
| 1 | | | value (CSV) score for routine clinical work done in the |
| | | | lapsed TF. The score may be calculated by: [routine |
| | | | clinical work]/[routine remuneration] * [constant]. |
| Routine CSV Score | S | S6.4.4 | A method that may generate a routine clinical service |
| 2 | | | value (CSV) score for routine clinical work done in the |
| | | | lapsed TF that is adjusted for the proportion of |
| | | | contracted clinical work amount required. The score |
| | | | may be calculated by: [routine clinical work]/([routine |
| | | | remuneration] * [effective clinical service rate]) * |
| | | | [constant] |
| OT TAT Score 1 | S | S6.5.1 | A method that may generate a TAT score for overtime |
| | | | work. The TAT may represent one or more time- |
| | | | intervals for one or more workflow processes. The |
| | | | score may be calculated by: [TAT]/[overtime work] * |
| | | | [constant]. |
| OT TAT Score 2 | S | S6.5.2 | A method that may generate a TAT score for overtime |
| | | | work that is adjusted for overtime work rate. The TAT |
| | | | may represent one or more time-intervals for one or |
| | | | more workflow processes. The score may be |
| | | | calculated by: [TAT]/[overtime work rate] * [constant]. |
| OT TAT Score 3 | S | S6.5.3 | A method that may generate a TAT score for overtime |
| | | | work that is adjusted for overtime work rate and |
| | | | number of non-clinical workdays during the TF. The |
| | | | TAT may represent one or more time-intervals for one |
| | | | or more workflow processes. The score may be |
| | | | calculated by: [TAT]/([overtime work rate] + ([non- |
| | | | clinical workdays] * [constant])) * [constant]. Non- |
| | | | clinical workdays are workdays that are worked but |
| | | | are not clinical service days. |
| Total TAT Score 1 | S | S6.5.4 | A method that may generate a TAT score for total |
| | | | work. The TAT may represent one or more time- |
| | | | intervals for one or more workflow processes. The |
| | | | score may be calculated by: [TAT]/[total work] * |
| | | | [constant]. |
| Total TAT Score 2 | S | S6.5.5 | A method that may generate a TAT score for total work |
| | | | that is adjusted for total work rate. The TAT may |
| | | | represent one or more time-intervals for one or more |
| | | | workflow processes. The score may be calculated by: |
| | | | [TAT]/[total work rate] * [constant]. |
| Total TAT Score 3 | S | S6.5.6 | A method that may generate a TAT score for total work |
| | | | that is adjusted for total work rate and number of non- |
| | | | clinical workdays during the TF. The TAT may |
| | | | represent one or more time-intervals for one or more |
| | | | workflow processes. The score may be calculated by: |
| | | | [TAT]/([overtime work rate] + ([non-clinical workdays] |
| | | | * [constant])) * [constant]. Non-clinical workdays are |
| | | | workdays that are worked but are not clinical service |
| | | | days. |
| Routine TAT Score | S | S6.5.7 | A method that may generate a TAT score for routine |
| 1 | | | work. The TAT may represent one or more time- |
| | | | intervals for one or more workflow processes. The |
| | | | score may be calculated by: [TAT]/[routine work] * |
| | | | [constant]. |
| Routine TAT Score | S | S6.5.8 | A method that may generate a TAT score for routine |
| 2 | | | work that is adjusted for routine work rate. The TAT |
| | | | may represent one or more time-intervals for one or |
| | | | more workflow processes. The score may be |
| | | | calculated by: [TAT]/[routine work rate] * [constant]. |
| Routine TAT Score | S | S6.5.9 | A method that may generate a TAT score for routine |
| 3 | | | work that is adjusted for routine work rate and number |
| | | | of non-clinical workdays during the TF. The TAT may |
| | | | represent one or more time-intervals for one or more |
| | | | workflow processes. The score may be calculated by: |
| | | | [TAT]/([overtime work rate] + ([non-clinical workdays] |
| | | | * [constant])) * [constant]. Non-clinical workdays are |
| | | | workdays that are worked but are not clinical service |
| | | | days. |
| Required Work | S | S6.6.1 | Using UserData, a method that may calculate the |
| Deficit | | | amount of work deficient of the contracted required |
| | | | work. The deficit or surplus of work may be calculated |
| | | | by: [0] − [contracted work required in total TF] − [work |
| | | | done in the lapsed TF]. |
| Contract Progress | S | S6.6.2 | Using UserData, a method that may calculate the |
| | | | contract progress as a ratio of work done in the lapsed |
| | | | TF to the work amount required in the total TF. The |
| | | | ratio may be calculated by: ([work done in lapsed TF]/ |
| | | | [contracted work required in total TF]) * [constant]. |
| | | | Alternatively, the progress may be presented as a ratio |
| | | | of work deficit in the lapsed TF to the work required to |
| | | | work in the total TF calculated by: ([work deficit in |
| | | | lapsed TF]/[contracted work required in total TF]) * |
| | | | [constant]. |
| Remaing | S | S6.7.1 | A method that may calculate the remaining timespan, |
| Timeframe | | | or remaining timeframe (TF), between the analysis |
| | | | date selected by the user and the TF end date. The |
| | | | analysis date may be the current date or other date |
| | | | between the total TF start date and total TF end date. |
| Required Work | S | S6.7.2 | Using UserData, a method that may calculate the |
| Outstanding | | | outstanding work that is still required to work in the |
| | | | remaining TF to satisfy the required contracted work |
| | | | for the total TF. The outstanding work may be |
| | | | calculated by: [0] − [work deficit]. The work deficit may |
| | | | be derived from S6.6.1. Alternatively, the outstanding |
| | | | work may be presented as a proportion of the |
| | | | contracted required work calculated by: [work deficit]/ |
| | | | [contracted work required in total TF] * [constant] |
| Capacity to Fulfill | S | S6.7.3 | Using UserData, a method that may calculate the |
| Required Work | | | capacity to fulfill the contracted required work. The |
| | | | capacity may be calculated by: [available workdays in |
| | | | remaining TF] − ([work deficit]/[estimated work done |
| | | | per workday]). Alternatively, the capacity may be |
| | | | presented as a ratio of remaining work to the |
| | | | remaining available workdays calculated by: [work |
| | | | deficit]/[estimated work done per workday]/ |
| | | | [available workdays in remaining TF] * [constant]. |

Referring back to FIG. 13, below is a summary of the blocks shown therein:

| Function/Method | | | |
|---|---|---|---|
| Name | Group | Label | Method Function |
| Source Data | S | S7.1 | A method that may display, store, share, or export a |
| Synopsis | | | synopsis of the source cases data used to generate |
| | | | the source WorkUnits. The method may also display, |
| | | | store, share, or export a synopsis of the Source |
| | | | WorkUnits used for analysis. |
| Source WorkUnits | S | S7.2 | A method that may display, store, share, or export a |
| List | | | list of Source WorkUnits. |
| WorkReport | S | S7.3 | A method that may display, store, share, or export a |
| Necessary | | | list of Necessary WorkUnits associated with each |
| WorkUnits List | | | WorkReport. |
| Selected WorkUnit | S | S7.4 | A method that may allow the user to select a WorkUnit |
| | | | from the Necessary WorkUnits list from S7.3. |
| WorkUnit Data | S | S7.5 | A method that may display, store, share, or export a |
| | | | synopsis of the WorkUnit Data from the WorkUnit |
| | | | selected by the user in S7.4. The WorkUnit Data |
| | | | includes the RuleData, CaseData, and Credit Data. |
| | | | The RuleData includes but is not limited to the rule log. |
| Associated Cases | S | S7.6 | A method that may display, store, share, or export a |
| List | | | list of source cases that are associated with one or |
| | | | more WorkReports. |
| Selected Case | S | S7.7 | A method that may allow the user to select a case from |
| | | | the list of cases associated with one or more |
| | | | WorkReports from method S7.6. |
| Case Synopsis | S | S7.8 | A method that may display, store, share, or export a |
| | | | synopsis of the case data from the case selected by |
| | | | the user in S7.7. |
| Case WorkReports | S | S7.9 | A method that may display, store, share, or export |
| | | | analytics or a WorkReport for the case selected by the |
| | | | user in S7.7. |

Referring back to FIG. 14, below is a summary of the blocks shown therein:

| Function/Method | | | |
|---|---|---|---|
| Name | Group | Label | Method Function |
| Colour Code | S | S1.1 | A method that may colour code user interface |
| Geographic Data | | | elements according to one or more physical or |
| | | | geographic locations including, but not limited to, |
| | | | countries, provinces, states, cities, counties, user |
| | | | defined zones or areas, institutions, collections sites, |
| | | | medical laboratories, departments, private entities, or |
| | | | hospitals. The user may use pre-set or custom colors |
| Colour Code Work | S | S1.2 | A method that may colour code user interface |
| Types | | | elements according to one or more work-types or |
| | | | groups of work-types including, but not limited to, |
| | | | clinical service work associated with direct patient |
| | | | care, research work, administrative work, teaching and |
| | | | training work, quality assurance and improvement |
| | | | work. Clinical service work-types may include, but are |
| | | | not limited to, base or core work associated with each |
| | | | case or case part, ancillary testing work, and |
| | | | consultation work. The user may use pre-set or custom |
| | | | colors. |
| Colour Code | S | S1.3 | A method that may colour code user interface |
| Disciplines | | | elements according to one or more laboratory |
| | | | medicine disciplines including, but not limited to, |
| | | | pathologists, anatomical pathologists, general |
| | | | pathologists, cytopathologists, medical examiners, |
| | | | autopsy pathologists, hematopathologists, molecular |
| | | | pathologists, surgical pathologists, transfusion |
| | | | medicine specialists, and medical microbiologists. The |
| | | | user may use pre-set or custom colors. |
| Colour Code | S | S1.4 | A method that may colour code user interface |
| Anatomical | | | elements according to one or more anatomical |
| Systems and Tissue | | | systems or tissue specimen types or groups of |
| Specimen Types | | | anatomical systems or tissue specimen types |
| | | | including, but not limited to, autopsy, breast, |
| | | | cardiovascular, cytology, endocrine, eye, |
| | | | gynecological, head and neck, hematopathology, |
| | | | neurological, musculoskeletal and soft tissue, lung, |
| | | | skin, urogenital, hepatobiliary, gastrointestinal, renal, |
| | | | perinatal, and pediatric systems. The user may use |
| | | | pre-set or custom colors. |
| Colour Code | S | S1.5 | A method that may colour code user interface |
| CaseLoad, | | | elements according to Relevant CaseLoad |
| WorkLoad, Primary, | | | WorkReports or Relevant WorkLoad WorkReports |
| Secondary, | | | including the respective Primary WorkLoad |
| Tertiary. | | | WorkReports, Primary CaseLoad WorkReports, |
| | | | Secondary WorkLoad WorkReports, and Tertiary |
| | | | CaseLoad WorkReports. The user may use pre-set or |
| | | | custom colors. |
| Colour Code | S | S1.6 | A method that may colour code user interface |
| Personnel | | | elements according to one or more personnel or |
| | | | groups of personnel. The user may use pre-set or |
| | | | custom colors. |
| Colour Code | S | S1.7 | A method that may colour code user interface |
| Date Times | | | elements according to one or more Dates, Times, or |
| | | | Timespans including, but not limited to, calendar |
| | | | years, fiscal years, months of the year, weeks of the |
| | | | year, days or the year, statutory holidays, weekend |
| | | | days, workdays, days of the month, days of the week, |
| | | | start dates, end dates, or turn around times. The user |
| | | | may use pre-set or custom colors. |
| Colour Code Source | S | S1.8 | A method that may colour code user interface |
| Data | | | elements according to one or more types of Medical |
| | | | Laboratory Reports or groups of Medical Laboratory |
| | | | Reports including, but not limited to, anatomical |
| | | | pathology reports, surgical pathology reports, |
| | | | cytopathology reports, molecular pathology reports, |
| | | | hematopathology reports, neuropathology reports, |
| | | | autopsy reports, flow cytometry reports, cytogenetics |
| | | | reports, electron microscopy reports, addenda, or any |
| | | | results pertaining to a specialized test or investigation |
| | | | pertaining to a tissue sample. The user may use pre- |
| | | | set or custom colors. |
| Colour Code | S | S1.9 | A method that may colour code the analytics of each |
| RuleSet Results | | | RuleSet for comparison to other RuleSets. The user |
| | | | may use pre-set or custom colors. |
| Colour Code Rule | S | S1.10 | A method that may colour code the analytics of one or |
| Change Results | | | more RuleSet rule changes. The user may use pre-set |
| | | | or custom colors. |
| P1 for Primary | S | S2.1 | A method that may use the text “P1” to provide to the |
| | | | user a graphic representation of the term “Primary” as |
| | | | it relates to the terms or concepts of “Primary” |
| | | | laboratory physicians, “Primary” cases, Relevant |
| | | | “Primary” CaseLoad WorkReports, Relevant “Primary” |
| | | | WorkLoad WorkReports. |
| S2 for Secondary | S | S2.2 | A method that may use the text “S2” to provide to the |
| | | | user a graphic representation of the term “Secondary” |
| | | | as it relates to the terms or concepts of “Secondary” |
| | | | laboratory physicians, “Secondary” cases, Relevant |
| | | | “Secondary” WorkLoad WorkReports. |
| T3 for Tertiary | S | S2.3 | A method that may use the text “T3” to provide to the |
| | | | user a graphic representation of the term “Tertiary” as |
| | | | it relates to the terms or concepts of Relevant |
| | | | “Tertiary” CaseLoad WorkReports. |
| CaseLoad | S | S2.4 | A method that may use the text “CaseLoad” to provide |
| | | | to the user a graphic representation of the term |
| | | | “caseload”. |
| WorkLoad | S | S2.5 | A method that may use the text “WorkLoad” to provide |
| | | | to the user a graphic representation of the term |
| | | | “workload”. |
| Emojis | S | S2.6 | A method that may provide to the user the analytics |
| | | | using emojis as graphical representations of workload |
| | | | levels. |
| Health | S | S2.7 | A method that may use the text “Health” as a heading |
| | | | to group and stratify analytics. |
| Forecast | S | S2.8 | A method that may use the text “Forecast” as a |
| | | | heading to group and extrapolate analytics. |
| ANTs | S | S2.9 | A method that may use the text “ANTs” to provide to |
| | | | the user a graphic representation of the term |
| | | | “ancillary”. |
| TAT | S | S2.10 | A method that may use the text “TAT” or “TATs” to |
| | | | provide to the user a graphic representation of the |
| | | | phrase “turn-around-time”. |
| Unit Conversion | S | S3.1 | A method that may convert the units of work |
| | | | measurement from one or more RuleSets to the units |
| | | | of work measurement of one or more other RuleSets |
| | | | or to a standard unit of currency or time. Units may |
| | | | also be converted to graphical motifs such as emojis. |
| | | | Units may also be converted into units of full-time |
| | | | equivalents (FTEs). |
| Analytics | | S3.2 | A method that may generate and provide for the user |
| Conversion | | | textual interpretations of numerical data. The method |
| Scheme | | | may provide textual directions that may provide to the |
| | | | user recommendations that may affect future |
| | | | analytics. |

Below is a glossary of terms used herein, especially with references to FIGS. 7-14:

| Index | Term | Definition |
|---|---|---|
| A | Accession | Cases received at a laboratory are assigned an accession |
| | | number. |
| A | Accession Site | The geographical location or physical site including but not |
| | | limited to, a hospital, where a case is accessioned. |
| A | Accession Number | One or more alphanumerical labels assigned to a case at the |
| | | time of accessioning for identification and tracking purposes. |
| C | CaseLoad | Analysis of WorkUnits for one or more cases or groups of |
| | | cases. |
| C | Total CaseLoad | Analysis of WorkUnits for one or more cases or one or more |
| | | groups of cases. Includes Primary CaseLoad and Tertiary |
| | | CaseLoad. |
| C | Primary CaseLoad | Analysis of WorkUnits of the Primary Laboratory Physician |
| | | for one or more cases or one or more groups of cases. |
| C | Tertiary CaseLoad | Analysis of WorkUnits of one or more Tertiary Laboratory |
| | | Physicians for one or more cases or one or more groups of |
| | | cases. |
| C | Case | Refers to one or more tissue samples procured from a single |
| | | patient or individual comprising one or more containers or |
| | | parts and generally obtained during a single patient |
| | | encounter. The collection of tissue samples is received at the |
| | | laboratory where it receives one or more accession numbers. |
| C | Primary Case | A case that a laboratory physician is considered to be |
| | | primarily responsible for. The laboratory medical report that |
| | | pertains to the case is generally verified or electronically |
| | | signed by the laboratory physician who is primarily |
| | | responsible for the case. |
| C | Secondary Case | A case that a laboratory physician is not considered to be |
| | | primarily responsible for. |
| C | Source Cases Data | All source data that pertains to the cases to be analyzed. |
| C | CreditData | Information that pertains to one or more Credit Physicians. |
| C | Credit Physician | Laboratory physician to whom work-value is accredited. |
| C | CaseData | Information that pertains to a case. |
| C | Cases Data | Cases Data represents a unified collection of a case-based |
| | | data per case that may derive from one or more sources. |
| C | Contracted | Expressed in workdays, identifies the target number of |
| | Workdays | workdays that a Laboratory Physician is contracted to work |
| | | in a specified timespan or timeframe. |
| C | Contracted Work | Expressed in one of many possible workload units, identifies |
| | Amount | the target work amount that a Laboratory Physician is |
| | | contracted to work in a specified timespan or timeframe. |
| C | Contracted FTE | Expressed in FTE units, identifies the target work amount |
| | | that a Laboratory Physician is contracted to work in a |
| | | specified timespan or timeframe. |
| C | Contracted Clinical | Identifies the target clinical service work amount that a |
| | Work Amount | Laboratory Physician is contracted to work in a specified |
| | | timespan or timeframe. It may be represented as a proportion |
| | | of contract work that is or should be allocated towards clinical |
| | | service work. |
| C | Clinical Service Work | Work-tasks performed by laboratory physicians pertaining to |
| | | patient care. |
| D | Duty | A work-task performed by a laboratory physician. |
| D | Days Worked | The number of days worked by a laboratory physician in a |
| | | specified timespan. |
| D | Days per 1.0 FTE | User defined number of days to work in a timespan that is the |
| | | equivalent of a full-time workload. Establishes the number |
| | | workdays that corresponds to 1.0 full time equivalent (1.0 |
| | | FTE). |
| D | Day | Refers to, but is not limited to each day's date, day of week, |
| | | day of month, day of year, as well as, each day's status as a |
| | | weekday, weekend day, workday, statutory holiday, and |
| | | proxy statutory holiday. |
| F | FiscalYear | A fiscal year. An accounting period of 12 months. |
| F | FiscalYear Data | Refers to, but is not limited to a user defined start date, end |
| | | date, list of included days, list of weeks and associated days |
| | | of the week, list of months and associated days of the month, |
| | | number of days, number of workdays, number of weekdays, |
| | | number of weekend days, number of statutory holidays and |
| | | proxy statutory holidays. |
| F | FTE Breakdown | Proportional split of contract FTE into subgroups of various |
| | | jobs, duties, or work-tasks including, not limited to, service |
| | | work, administrative work, teaching, training, or research. |
| F | FTE | Full time equivalent, or whole value equivalent, is a unit of |
| | | measurement that may be converted to a fraction or |
| | | percentage of a whole, whereby 1.0 is a full value and 0.5 is |
| | | a half value. |
| J | Job | A work-task performed by a laboratory physician. |
| L | Laboratory Medical | A laboratory medical report (LMR) is issued to report the |
| | Report | analysis results or outcome of a tissue sample. One or more |
| | | LMRs may be issued per case. Each LMR is verified by a |
| | | laboratory physician. The LMR may be reported in the |
| | | patient's medical report. Types of LMRs include, but are not |
| | | limited to, anatomical pathology reports, surgical pathology |
| | | reports, cytopathology reports, molecular pathology reports, |
| | | hematopathology reports, neuropathology reports, autopsy |
| | | reports, flow cytometry reports, cytogenetics reports, |
| | | electron microscopy reports, corrected reports, addenda, or |
| | | any results pertaining to a specialized test or investigation |
| | | pertaining to a tissue sample. |
| P | Laboratory (Lab) | Refers to, but is not limited to pathologists, anatomical |
| | Physician | pathologists, general pathologists, clinical pathologists, |
| | | cytopathologists, medical examiners, autopsy pathologists, |
| | | hematopathologists, molecular pathologists, surgical |
| | | pathologists, transfusion medicine specialists, and medical |
| | | microbiologists. |
| P | Primary Laboratory | The laboratory physician who is considered to be primarily |
| | Physician | responsible for a case. |
| P | Secondary | A laboratory physician who is not considered to be primarily |
| | Laboratory Physician | responsible for a case. |
| P | Personnel Data | Laboratory physician data includes but is not limited to days |
| | | worked, vacation days, and contracted work terms and |
| | | information. |
| R | Roster | A group of one or more Laboratory Physicians. |
| R | RuleSet | A RuleSet comprises one or more rules. |
| R | Rule | Represents one or more instructions that determine the value |
| | | of a task. |
| R | RuleData | RuleData comprises one or more parameters. Rule |
| | | parameters may include, but are not limited to, one or more |
| | | work-task types, one or more work-values, one or more |
| | | relevant case data parameters derived from one or more |
| | | case attributes and corresponding case values, one or more |
| | | modifiers, one or more conditions, or one or more actions. |
| | | The rule parameters constitute the rule instructions used to |
| | | determine the value of a work-task. |
| R | Focus-rule | The rule selected by the user to create, modify, delete, |
| | | examine, analyze, or test. |
| R | Rule Modification | One or more parameters that may modify the work-value that |
| | Factor | is assigned to one or more work-tasks. |
| R | Rule Condition | One or more parameters that may be used for evaluation to |
| | | determine the action or outcome of a rule. |
| R | Relevant | Analytics or results that pertain to the analysis of WorkUnits |
| | WorkReport | that are limited in scope and dependent on one or more |
| | | UserData parameters. |
| T | Task | Work-task performed by a laboratory physician. |
| T | Turn Around Times | The time interval from the start time to the completion time of |
| | | a process in laboratory medicine. |
| U | User Account Data | Information pertaining to User preferences that may include |
| | | but is not limited to User Permissions, User identification, |
| | | User login information, and information pertaining to the |
| | | user's work contract terms. |
| U | User Permission | Parameters that determine user access to data and analytics. |
| | Data | |
| U | Unit | The unit of measurement used by a RuleSet to place |
| | | absolute or relative value on one or more work-tasks. |
| U | Unit Conversion | The conversion of a unit of a RuleSet to an absolute value, |
| | | such as a unit of time, FTE, or currency, or the conversion of |
| | | the unit of one RuleSet to the unit of another RuleSet. |
| U | User | Includes but is not limited to one or more laboratory |
| | | physicians, laboratory agents, regulatory body agents, |
| | | private entity agents, government agents, institution agents, |
| | | administrators, or any other individual or groups of individuals |
| W | WorkUnit | A WorkUnit represents the information that pertains to work- |
| | | value that has been assigned to one or more work-tasks. The |
| | | WorkUnit has WorkUnit Data that is composed of the |
| | | CaseData, WorkData, and CreditData. |
| W | WorkData | WorkData includes, but is not limited to, the type of work-task |
| | | done including one or more categories of work, a base work- |
| | | value, a quantity value, a total work-value, a record of the |
| | | instructions or rules used to generate the work value, a |
| | | record of instructions that may by used for further |
| | | modifications of the work value to be used in subsequent |
| | | analyses, as well as, date, time, and timespan records |
| | | associated with the work-task. |
| W | WorkUnit Data | All data related to an individual WorkUnit. Comprises |
| | | WorkData, CaseData, and CreditData. |
| W | Necessary | The WorkUnits required to generate a Relevant WorkReport |
| | WorkUnits | |
| W | WorkReport | Analytics or results that pertain to the analysis of WorkUnits. |
| W | WorkLoad | Analysis of WorkUnits for one or more Lab Physicians or |
| | | groups of Lab Physicians. Includes primary and secondary |
| | | workload. |
| W | Total WorkLoad | Analysis of WorkUnits for one or more Lab Physicians or |
| | | groups of Lab Physicians. |
| W | Primary WorkLoad | Analysis of WorkUnits for one or more Lab Physicians or |
| | | groups of Lab Physicians using Primary Cases. |
| W | Secondary | Analysis of WorkUnits for one or more Lab Physicians or |
| | WorkLoad | groups of Lab Physicians using Secondary Cases. |
| W | WorkUnit List | List of WorkUnits pertaining to a WorkReport |
| W | Work | Work, work-tasks, tasks, jobs, or duties performed by one or |
| | | more laboratory physicians. |
| W | Work-task | Represents a task, job, or duty performed by one or more |
| | | laboratory physicians. |
| W | Workday | A calendar day that may be worked by a Laboratory |
| | | Physician to perform work. |
| W | WorkData | A portion of the output of a rule method. The WorkData |
| | | contains information that pertains to the work-value that is |
| | | assigned to the work-task or work performed. The WorkData |
| | | forms a portion of a WorkUnit. The WorkData may include |
| | | but is not limited to the type of work, one or more categories |
| | | of work, a base work value, a quantity value, a total work |
| | | value, a record of instructions or rules used to generate the |
| | | work value, a record of instructions for further modifications |
| | | of the work value to be used in subsequent analyses, as well |
| | | as, date, time, and timespan records associated with the |
| | | work-task. |
| W | Total Work | Total work is the sum of routine work and overtime work. |
| W | Routine Work | Work performed as part of routine service work for routine |
| | | remuneration. |
| W | OT Work | Overtime work performed for additional remuneration. |
| W | Work Rate | The ratio of work done to number of workdays during which |
| | | the work was assigned. |
| W | Raw Work Data | Raw Work Data pertains to case information and any record |
| | | of work performed by laboratory physicians. The information |
| | | may include, but is not limited to, Laboratory Medical Reports |
| | | or workflow tracking information including, but not limited to, |
| | | records of cases and associated tissue specimens, tissue |
| | | blocks, routine histological slides, ancillary histological tissue |
| | | blocks or histological slides, routine ancillary tests, |
| | | specialized ancillary tests, records of consultations, records |
| | | of communications, records of quality assurance and |
| | | improvement work, records of teaching and training, records |
| | | of research work, records of administrative work, and any |
| | | recorded information that one or more RuleSets may |
| | | recognize as a work-task that may have an associated work- |
| | | value. |
| W | Conditioned Work | Conditioned Work Data may include, but is not limited to, |
| | Data | information that has been validated for data type quality, data |
| | | accuracy, and data completeness. Incorrect data types may |
| | | be corrected. Inaccurate or incomplete data may be |
| | | substituted with one or more placeholder or default values |
| | | from one or more digital files or user inputted data. |
| W | Sample Work Data | Sample Work Data may include, but is not limited to, code |
| | | generated data or user inputted data that is representative of |
| | | a data source that the user may wish to simulate. |
| W | Work-value | The value assigned to one or more work-tasks. The unit of |
| | | the value may be, but is not limited to, one or more units of |
| | | time, currency, FTEs, or points. |

The scope of the claims should not be limited by the preferred embodiments set forth in the examples but should be given the broadest interpretation consistent with the specification as a whole.

1. A method for assessing workload in an organization for whom a plurality of workers perform work of different types and on different matters, the method comprising:
providing, in a database system including one or more databases, a plurality of work entries respectively representative of the work performable by one or more of the workers in relation to an associated one of the matters, wherein each of the work entries includes data representative of:
the associated matter,
one of the types of work, and
one of the workers;
retrieving, from the database system, respective ones of the work entries associated with a selected one of the matters for which workload is to be assessed;
based on a selected one of a plurality of work measurement rulesets each comprising one or more rules respectively associated with the types of work that can be performed, generating respective ruleset-assessed entries for relevant ones of the work entries of the selected matter indicating the types of work identified in the selected work measurement ruleset, wherein each of the ruleset-assessed entries comprises data representative of:
the selected matter;
the type of work,
a rule-defined value of the work based on a corresponding one of the rules of the ruleset and the type of work, and
the worker; and
storing the ruleset-assessed entries in the database system distinctly from the work entries such that both the ruleset-assessed and work entries are available for subsequent retrieval.

2. The method of claim 1 further including, after generating respective ruleset-assessed entries for relevant ones of the work entries indicating the types of work identified in the selected work measurement ruleset, receiving, from a user conducting an assessment of workload, a modification to a respective one of the rules of the work measurement ruleset and displaying a differential value representative of a cumulative change in modified rule-defined values of affected ones of the ruleset-assessed entries based on the modified rule.

3. The method of claim 1 further including, after generating respective ruleset-assessed entries for relevant ones of the work entries indicating the types of work identified in the selected work measurement ruleset, receiving, from a user conducting an assessment of workload, a modification to a cumulative value representative of all of the rule-defined values of the ruleset-assessed entries and determining a modification to the work measurement rulesets to effect the modification to the cumulative value.

4. The method of claim 1 wherein generating respective ruleset-assessed entries for relevant ones of the work entries of the selected matter is iterated for multiple ones of the work measurement rulesets applied to the selected matter.

5. The method of claim 1 wherein storing the ruleset-assessed entries in the database system distinctly from the work entries comprises grouping the ruleset-assessed entries by at least one of (i) the rules of the selected workload measurement ruleset, (ii) the selected matter, and (iii) the selected workload measurement ruleset.

6. The method of claim 1 wherein, when the work entries include data indicating whether the work represented thereby has been completed, and the ruleset-assessed entries include said data, the method further includes generating a work report including only prescribed ones of the ruleset-assessed entries with data indicating that the work represented thereby is complete.

7. The method of claim 6 wherein generating a work report including only prescribed ones of the ruleset-assessed entries comprises the prescribed ruleset-assessed entries of one of (i) a common one of the matters, (ii) a common one of the workers, and (iii) a common one of the types of work.

8. The method of claim 1 further including:
receiving, as input, a user-generated document having a plurality of fields respectively containing data in the form of at least one of text and numbers and representative of work in relation to a respective one of the matters; and
generating work entries based on the data in the fields of the user-generated document.

9. The method of claim 1 wherein, when one or more of the relevant work entries are determined to be unassigned to the workers, generating respective ruleset-assessed entries for relevant ones of the work entries of the selected matter indicating the types of work identified in the selected work measurement ruleset comprises generating one or more estimated ruleset-assessed entries with the data representative of one of the matters, the type of work and the rule-defined value of the work but without the data indicating the worker.

10. The method of claim 9 further including remotely transmitting the estimated ruleset-assessed entries to relevant ones of the workers identified as capable of performing the type of work indicated in the estimated ruleset-assessed entries to procure one of the relevant workers to perform the work represented thereby.
